(19) United States
(12) Patent Application Publication
(10) Pub. No.: US 2026/0241369 A1
(43) Pub. Date: Aug. 20, 2026

(54) HYDROPHOBIC ACIDIC GAS ABSORBENTS

(71) Applicant: Commonwealth Scientific and Industrial Research Organisation, Acton, Australian Capital Territory (AU)

(72) Inventors: Colin WOOD, Kensington (AU); Cameron WHITE, Kensington (AU); Zhijian WAN, Kensington (AU)

(21) Appl. No.: 19/128,489

(22) PCT Filed: Nov. 9, 2023
(86) PCT No.: PCT/AU2023/051129

§ 371 Date: May 8, 2025

(30) Foreign Application Priority Data
Nov. 9, 2022 (AU) 2022903348

(51) Int. Cl. B01J 20/26; B01D 53/02; B01D 53/62; B01D 53/81; B01J 20/28; B01J 20/32; B01J 20/34

(52) U.S. Cl. CPC B01J 20/267; B01D 53/02; B01D 53/62; B01D 53/81; B01J 20/28047; B01J 20/3212; B01J 20/3219; B01J 20/3251; B01J 20/3272; B01J 20/3425; B01J 20/3483; B01D 2252/20405; B01D 2252/20426; B01D 2253/202; B01D 2253/25; B01D 2257/504; B01D 2259/40088

(57) ABSTRACT

The present disclosure relates generally to acidic gas absorbents. In particular, the present disclosure relates to acidic gas absorbent particulate comprising support particles incorporating one or more acidic gas absorbents, and a hydrophobe physically absorbed on or within the support particles, which can be used to capture one or more acidic gases from a gaseous stream or atmosphere.

### FIELD

The present disclosure relates generally to acidic gas absorbents. In particular, the present disclosure relates to an acidic gas absorbent particulate comprising support particles and a hydrophobe, which can be used to capture one or more acidic gases from a gaseous stream or atmosphere. The present disclosure also relates to processes, methods, systems, uses and apparatus comprising the acidic gas absorbent particulate for capturing acidic gases from a gaseous stream or atmosphere.

### BACKGROUND

Acidic gases such as carbon dioxide (CO₂), sulfur gases (e.g. SO₂ and H₂S) can cause significant environmental pollution and health risks. There has been increasing concern about the damage caused by these contaminants, which has led to an increase demand to reduce their emission, including CO₂.

Separation of acidic gases from gas streams can be achieved via chemical absorption or chemical/physical absorption processes. The most widely used process for CO₂ separation and capture from acidic gas-containing streams is the chemical absorption process utilising liquid amine solutions. Aqueous solutions of monoethanolamine (MEA) or diethanolamine (DEA) are commonly used in the wet chemical absorption and low-pressure stripping of CO₂. In this process, the CO₂ reacts with the liquid amine solution to form a carbamate species. Upon heating, the carbamate species decomposes to release the absorbed CO₂ and regenerate the amine solution. This process can be costly and energy intensive. For example, liquid amine solutions have low capture efficiency arising from gas-liquid contact area limitations, require intensive energy requirements for desorption of CO₂ from the liquid solution, are corrosive to steel pipes, and are prone to thermal and/or chemical degradation of the amine groups.

Solid adsorbents having high surface areas, such as amine-functionalized porous supports, zeolites, carbons and metal organic frameworks (MOFs) have been widely investigated for acidic gas capture. In such materials, the porosity retained in the framework contains CO₂ absorbents or is functionalised with reactive groups to retain CO₂ uptake within the pores. Among these adsorbents, amine-functionalized porous materials have been most extensively investigated due to their ability to chemisorb low-concentration CO₂ from a gas stream. The adsorbents can be prepared by impregnating polymeric amines such as polyethylenimine (PEI) into porous supports, such as silica, by grafting aminosilanes on the pore surfaces or by in situ polymerization of amine monomers within the support. Many of these porous supports demonstrate poor heat transfer, poor performance in the presence of water and limited thermo-chemical stability, including decreased stability over time and reduced gas absorption performance due to degradation owing to water uptake from the atmosphere.

Accordingly, there is a need for more effective materials for use in acidic gas capture which overcome at least one or more of the problems discussed above and/or provides the public with a useful alternative.

It will be understood that any prior art publications referred to herein do not constitute an admission that any of these documents form part of the common general knowledge in the art, in Australia or in any other country.

### SUMMARY

The present disclosure provides particular acidic gas absorbents for removing acidic gases from gaseous streams or atmospheres, that are scalable for industrial application and can be tailored to provide control over acidic gas absorption and/or desorption. In particular, the acidic gas absorbents described herein can remove acidic gases (e.g. CO₂, H₂S or SO₂) from gaseous streams or atmospheres by absorbing the acidic gas thereby removing it from the gaseous stream or atmosphere. The absorbed acidic gas can then be harvested (e.g. desorbed) from the absorbent, which is regenerated and can be reused to absorb more acidic gas from the gaseous stream or atmosphere (e.g. recycled).

It has now been found that an acidic gas absorbent comprising a hydrophobe absorbed on or within a support is an effective absorbent for the capture of acidic gas. In particular, it has been surprisingly found that an acidic gas absorbent particulate comprising a hydrophobe absorbed on or within a particulate support can demonstrate reduced water uptake during acidic gas capture whilst retaining good acidic gas absorption properties. Despite the presence of the hydrophobe (which in some cases may be comprise a viscous material, such as silicone oil or paraffin wax), the acidic gas absorbent particulate surprisingly remains “dry” and flowable, which allows it to be introduced into gas pipelines such as for use in in-line post combustion CO₂ capture from flue gas.

In one aspect, there is provided an acidic gas absorbent particulate for capture of acidic gas comprising support particles incorporating one or more acidic gas absorbents, and a hydrophobe absorbed on or within the support particles. In another aspect, there is provided an acidic gas absorbent particulate for capture of acidic gas comprising support particles incorporating one or more acidic gas absorbents, and a hydrophobe physically absorbed on or within the support particles.

In another aspect, there is provided a process for preparing an acidic gas absorbent particulate for capture of acidic gas, comprising contacting a hydrophobe with support particles incorporating one or more acidic gas absorbents under conditions effective to absorb the hydrophobe on or within the support particles. In another aspect, there is provided a process for preparing an acidic gas absorbent particulate for capture of acidic gas, comprising contacting a hydrophobe with support particles incorporating one or more acidic gas absorbents under conditions effective to physically absorb the hydrophobe on or within the support particles.

In another aspect, there is provided a method for removing an acidic gas from a gaseous stream or atmosphere, the method comprising contacting the gaseous stream or atmosphere with an acidic gas absorbent particulate as described above to absorb at least some of the acidic gas from the gaseous stream or atmosphere into the support particles.

In another aspect, there is provided an acidic gas removal apparatus comprising a chamber enclosing an acidic gas absorbent particulate for capture of acidic gas from a gaseous stream or atmosphere as described above, wherein the chamber brings the gaseous stream or atmosphere into contact with the particulate to absorb at least some of the acidic gas into the support particles.

It will be appreciated that any one or more of the embodiments and examples described herein for the acidic gas absorbent particulate may also apply to the processes, methods and/or apparatus described herein. Any embodiment herein shall be taken to apply mutatis mutandis to any other embodiment unless specifically stated. It will also be appreciated that other aspects, embodiments and examples of the acidic gas absorbent particulate, processes, methods and/or apparatus are described herein.

It will also be appreciated that some features of acidic gas absorbent particulate, processes, methods and/or apparatus identified in some aspects, embodiments or examples as described herein may not be required in all aspects, embodiments or examples as described herein, and this specification is to be read in this context. It will also be appreciated that in the various aspects, embodiments or examples, the order of method or process steps may not be essential and may be varied.

### BRIEF DESCRIPTION OF FIGURES

Preferred embodiments of the present disclosure are further described and illustrated as follows, by way of example only, with reference to the accompanying drawings in which:

FIGS. 1A and 1B: A) Illustration of the fabrication and structure of an acidic gas absorbent particulate according to one or more embodiments of the present disclosure, where a hydrophobe (e.g. surfactant) is physically absorbed on or within support particles. B) Photo of an acidic gas absorbent particulate comprising DEA swollen PEI particles before and after silicone coating showing the effect on water contact.

FIG. 2: Water uptake within silicone oil coated DEA swollen PEI particles during CO₂ capture.

FIG. 3. Flow-cell testing rig for DAC evaluation of silicone oil coated DEA swollen PEI particles.

FIGS. 4A and 4B: A) The changes in CO₂ uptake of the DEA swollen PEI particles before and after the coating as a function of time for 24 h. B) The changes in H₂O uptake of the PEI particles before and after the coating as a function of time for 24 h.

FIG. 5: Depicts an apparatus for performing the method for capture of an acidic gas from a gaseous stream or atmosphere, according to some embodiments of the disclosure.

FIGS. 6 to 9: CO₂ uptake of DEA swollen PEI particles comprising various hydrophobe-functionalised amine liquids.

FIG. 10: CO₂ uptake in hydrophobe-grafted DEA swollen PEI particles.

### DETAILED DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, hydrogels, processes, and compositions, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

As used herein, the term “about”, unless stated to the contrary, typically refers to a range of up to +/−10% of the designated value, and includes smaller ranges therein, for example +/−5% or +/−1% of the designated value.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 4.5, 4.75, and 5, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The reference to “substantially free” generally refers to the absence of that compound or component in the acidic gas absorbent particulate, gaseous stream or atmosphere other than any trace amounts or impurities that may be present, for example this may be an amount by weight % in the total acidic gas absorbent particulate, gaseous stream or atmosphere of less than about 1%, 0.1%, 0.01%, 0.001%, or 0.0001%. The acidic gas absorbent particulate, gaseous streams or atmosphere as described herein may also include, for example, impurities in an amount by weight % in the total acidic gas absorbent particulate, gaseous stream or atmosphere of less than about 5%, 4%, 3%, 2%, 1%, 0.5%, 0.1%, 0.01%, 0.001%, or 0.0001%. For example, this may be an amount by vol. % in the total gaseous stream or atmosphere of less than about 5%, 4%, 3%, 2%, 1%, 0.5%, 0.1%, 0.01%, 0.001%, or 0.0001%. For example, the gaseous streams or atmospheres as described herein may also include, for example, impurities in an amount by vol. % in the total gaseous stream of less than about 5%, 4%, 3%, 2%, 1%, 0.5%, 0.1%, 0.01%, 0.001%, or 0.0001%. An example of such an impurity is the amount of methane (CH₄) that may be present in air, being present in an amount of less than 0.0005 vol. %.

The term “acidic gas” means any one or more of carbon dioxide (CO₂), hydrogen sulfide (H₂S), carbon disulfide (CS₂), carbonyl sulfide (COS), mercaptans (R—SH, where R is an alkyl group having one to 20 carbon atoms), sulfur dioxide (SO₂), combinations thereof, mixtures thereof, and derivatives thereof. The acidic gas absorbent particulate of the present disclosure is particularly suitable for absorption of carbon dioxide and/or hydrogen sulfide from gaseous streams or atmospheres.

As used herein, “weight %” may be appreciated to “wt. %” or % w/w”.

### Acidic Gas Absorbent Particulate

The present disclosure describes the following various non-limiting embodiments, which relate to investigations undertaken to identify acidic gas absorbents for capturing acidic gas from gaseous streams or atmospheres. Additional non-limiting embodiments of the acidic gas absorbents and various processes, methods and apparatus are also described.

The acidic gas absorbent particulate described herein comprises support particles incorporating one or more acidic gas absorbents and a hydrophobe, which is further described below according to various non-limiting embodiments and examples.

It has been surprisingly found that the acidic gas absorbent particulate described herein provided one or more advantages over conventional liquid and/or solid-based absorbents including, but not limited to, reduced water uptake during acidic gas capture whilst retaining good acidic gas absorption properties, improved robustness in humid environments, and/or reduced environmental impact.

The present disclosure provides an acidic gas absorbent particulate for capture of acidic gas from a gaseous stream or atmosphere comprising support particles incorporating one or more acidic gas absorbents, a hydrophobe absorbed (e.g. physically absorbed) and in some cases absorbed liquid, on or within the support particles.

The acidic gas absorbent is a particulate. The term “particulate” refers to the form of discrete solid units. The units may take the form of flakes, fibres, agglomerates, granules, powders, spheres, dust, pulverized materials or the like, as well as combinations thereof. The particulate may have any desired shape including, but not limited to, cubic, rod like, polyhedral, spherical or semi-spherical, rounded or semi-rounded, angular, irregular, and so forth. The particulate morphology can be determined by any suitable means such as optical microscopy. The particulate comprises support particles as described herein.

In some embodiments, the mean average particle size (in μm) of the acidic gas absorbent particulate (e.g. the size of the support particles comprising the hydrophobe, acidic gas absorbent and optionally any absorbed liquid) may be at least about 0.01, 0.1, 1, 5, 10, 20, 50, 100, 200, 300, 400, 500, 700, 1000, 1500, 2000, 5000 or 10,000. In some embodiments, the mean average particle size (in μm) of the acidic gas absorbent particulate may be less than about 10,000, 5000, 2000, 1500, 1000, 700, 500, 400, 300, 200, 100, 50, 20, 10, 5, 1, 0.1, or 0.01. The mean average particle size of the acidic gas absorbent may be in a range provided by any two of these upper and/or lower values, for example the mean average particle size (in μm) may be between about 0.01 to about 10,000, between about 0.1 to about 5000, between about 10 to about 2000, between about 10 to about 1000, or between about 10 to about 500. In one embodiment, the acidic gas absorbent particulate has a has a mean average particle size (μm) of between about 10 to about 2000.

The acidic gas absorbent particulate may have a particle size (D₅₀) of between about 0.01 μm to about 5000 μm. The acidic gas absorbent particulate may have a particle size (D₅₀) of at least about 0.01, 0.1, 1, 10, 20, 50, 100, 200, 300, 400, 500, 700, 1000, 1500, 2000, or 5000 μm. The acidic gas absorbent particulate may have a particle size (D₅₀) of less than about 5000, 2000, 1500, 1000, 700, 500, 400, 300, 200, 100, 50, 20, 10, 1, 0.1 or 0.01 μm. Combinations of these D₅₀ particle size values to form various ranges are also possible, for example the acidic gas absorbent particulate may have a particle size (D₅₀) of between about 0.1 μm to about 2000 μm or between about 10 μm to about 500 μm. The D₅₀ particle size is defined such that 50 volume % of the particles is present in particles having a size less than the d50 particle size.

The particle size of the acidic gas absorbent particulate is taken to be the longest cross-sectional diameter across an acidic gas absorbent particle. For a non-spherical acidic gas absorbent particulate, the particle size is taken to be the distance corresponding to the longest cross-section dimension across the particle. The mean average particle size can be determined by any standard method, including for example optical microscope, dynamic light scattering and/or electron microscopy (SEM or TEM) techniques. An acidic gas absorbent particulate may provide one or more advantage, including for example an increased surface area for greater contact and subsequent absorption of acidic gas.

In some embodiments, the acidic gas absorbent particulate is flowable (i.e. exhibits dry and powdery properties) allowing it to flow as a loose particulate without being overly sticky or rigid. It has been surprisingly found that such a free-flowing powder could be achieved despite the particulate having a hydrophobe physically absorbed on or within the support particles (which in some cases is a viscous material, such as silicone oil or paraffin wax). Such free-flowing properties makes it convenient to handle and transport the particulate, even when the particulate comprises a high content of absorbed liquid. Advantageously, the particulate remains in the form of a dry, free-flowing powder, i.e. without substantial escape of the absorbed liquid and/or hydrophobe to the outside of the particles, even when acidic gas is absorbed. The free-flowing nature of the acidic gas absorbent particulate may provide certain advantages, for example allows particulate of the acidic gas absorbent material to be contacted with the gaseous stream or atmosphere using a fluidized bed reactor.

In a related embodiment, the acidic gas absorbent particulate may be self-supporting. The term ‘self-supporting’ as used herein refers to the ability of the acidic gas absorbent particulate to maintain its morphology in the absence of an external scaffold material, such as a porous zeolite or a metal organic framework (MOF). Thus it will be understood that, where the acidic gas absorbent particulate is “self-supporting”, there is no exogenous scaffold required to maintain the structure of the acidic gas absorbent particulate.

In some embodiments, the acidic gas absorbent particulate may be provided as layer within a column, wherein the gaseous stream or atmosphere is flowed through the column and passes through the layer comprising the acidic gas absorbent particulate. The layer is not limited to any particular morphology. In one example, a suitable column may be packed with a particulate of acidic gas absorbent to form a packed-bed with sufficient interstitial space between adjacent particles to allow a flow of gas therethrough. Alternatively, the acidic gas absorbent particulate may be provided in flow with the gaseous stream or atmosphere (e.g. a fluidised bed reactor).

In some embodiments, the acidic gas absorbent particulate may be provided as a coating composition on a substrate. In some embodiments, the substrate may be planar, for example a planar sheet. In a particular example, the substrate may be a flexible sheet. A planar substrate provides a two sided element onto which the acidic gas absorbent particulate coating composition can be applied. Each substrate may be coated with the acidic gas absorbent particulate coating composition on two opposing sides. The planar substrate can have any configuration. In some embodiments, the planar substrate may comprise a flat solid surface. In other embodiments, the planar substrate may comprise one or more apertures, designed to assist gas flow through and around the substrate. In a particular embodiment, the substrate may comprise a mesh, for example, micro wire mesh. The use of a mesh provides a multitude of apertures, (e.g. micro size apertures), thereby providing a high surface area on which the acidic gas absorbent particulate coating composition can be applied, whilst also providing a suitable flow path having a reasonably low pressure drop across the substrate (relative to the size and configuration of the mesh) compared to other configurations, for example, packed beds.

### Support Particles

The acidic gas absorbent particulate comprises support particles incorporating one or more acidic gas absorbents, and a hydrophobe physically absorbed on or within the support particles. As used herein, the term “support particles” refers to particles of solid material that can absorb and hold a liquid, for example a hydrophobe and/or an acidic gas absorbent, whilst maintaining its physical structure.

In one embodiment, the support particles are swellable. As used herein, the term “swellable” refers to the support particles ability to swell as liquid is absorbed therein. Importantly and unlike porous or mesoporous silica or alumina, carbonized biomass such as activated carbon, and other more complex inorganic scaffold and supports, such as zeolites (including molecular sieves) or metal organic frameworks (MOFs), in some embodiments, the support particles are capable of swelling beyond its initial dry state pore volume (that is increasing in overall particle size), which is seen for example when using hydrogels. According to some embodiments or examples, the swelling ability of the support particles helps to retain liquid absorbed therein, such as a hydrophobe and/or an acidic gas absorbent, which can lead to improved performance, such as enhanced reduction in water uptake during acidic gas capture whilst retaining good acidic gas absorption properties. In a related embodiment, the network forming the support particles is capable of expanding when swollen with an absorbed liquid. Despite the advantages associated with using swellable support particles, such as hydrogels, this of course does not preclude the use of the more conventional porous supports (such as molecular sieves) as support particles, which the present disclosure highlights can also incorporate an acidic gas absorbent and have a hydrophobe absorbed on or therein which provides reduced water uptake and/or good acidic gas capture efficiency during acidic gas capture. However according to some embodiments or examples, it has been identified by the present inventors that swellable supports, such as hydrogels, can provide improved performance.

The support particles have a median dry state pore diameter, being the diameter of the pores within the particles prior to absorption of hydrophobe and/or liquid. In one embodiment, the solid support particles have a median dry state pore diameter (in nm) of less than about 100, 20, 10, 5, 2, 1 or 0.1. In one embodiment, the pores can have a median dry state pore diameter of between about 0.1 nm to about 100 nm, between about 0.1 nm to about 20 nm, between about 0.1 nm to about 5 nm, or between about 0.1 nm to about 2 nm, with no particular distribution of shape or size required. In other embodiments, the solid support particles have a median dry state pore diameter of no more than about 5 nm, or no more than about 2 nm.

In some embodiments, the solid support particles have a low porosity, such as those seen for hydrogels described herein. In one embodiment, the solid support particles do not have a dry state porosity. For example, the solid support particles may be essentially non-porous in the dry state. When swollen with a liquid, the solid support particles swell beyond the initial dry state pore volume. As a result, the porosity of the swollen support particles increases (i.e. the particles have a “liquid” based porosity).

According to some embodiments or examples described herein, when swollen with a liquid, microdroplets of liquid within the solid support are created, resulting in the acidic gas diffusion distance being significantly reduced allowing for enhanced sorbent uptake kinetics/efficiency, giving rise to improved performance. If the liquid is removed from the solid support particles (for example by freeze drying), the solid support particles do not retain a measurable dry state porosity. In contrast, porous silica, MOFs and other zeolites, such as molecular sieves, will take up liquid but does not swell beyond its dry state pore volume.

It will be appreciated that the embodiments described above in relation to the morphology and/or particulate size for the acidic gas absorbent particulate may equally apply for the support particles.

The mean average particle size of the dry support particles (e.g. prior to being absorbed with liquid) is typically less than the mean average particle size of the acidic gas absorbent particulate (e.g. when absorbed with a liquid). In some embodiments, the mean average particle size (in μm) of the dry support particles at least about 0.01, 0.1, 1, 5, 10, 20, 50, 100, 200, 300, 400, 500, 700, 1000, 1500, 2000 or 5000. In some embodiment, the mean average particle size (in μm) of the support particles may be less than about 5000, 2000, 1500, 1000, 700, 500, 400, 300, 200, 100, 50, 20, 10, 5, 1, 0.1 or 0.01. The mean average particle size of the support particles may be in a range provided by any two of these upper and/or lower values, for example the mean average particle size (in μm) may be between about 0.01 to about 5000, between about 10 to about 2000, between about 10 to about 1000, or between about 10 to about 500. In one embodiment, the support particles have a mean average particle size (μm) of between about 10 to about 2000. Support particles may provide one or more advantages, including for example an increased surface area for greater contact and subsequent absorption of acidic gas. The support particles may also be pelletized to increase the particle size, for example, for use in packed bed column applications to mitigate pressure drop across the bed.

The surface area of the dry support particles (e.g. prior to being absorbed with liquid) can vary depending on their morphology and/or size. In some embodiments, the dry support particles may have a surface area (in m² per gram of support (m²/g)) of at least about 0.1, 0.2, 0.5, 0.7, 1, 2, 3, 4, 5, 6, 7, 8, 9, 10, 15, 20, 25, 30, 35, 40, or 50. In some embodiments, the dry support particles may have a surface area (in m²/g) of less than about 50, 45, 40, 35, 30, 25, 20, 15, 10, 9, 8, 7, 6, 5, 4, 3, 2, or 1. The surface area may be in a range provided by any two of these upper and/or lower values, for example the dry support particles may have a surface area (in m²/g) of between about 0.1 to 40, 0.1 to 10, or 0.1 to 5. In other embodiments, the dry support particles has high surface area, for example greater than 500 m²/g, or greater than 700 m²/g. The surface area can be measured using N₂ adsorption with Brunauer-Emmett-Teller (BET) theory applied over the relative pressure range of 0.05 to 0.20 P/P₀ at 77 K.

The support particles may be made of any suitable material capable of absorbing and retaining the hydrophobe, and in some embodiments absorbed liquid, on or within the support. In some embodiments, the support particles are formed from a material selected from the consisting of polymeric materials (such as hydrogels, cellulose materials, hypercrosslinked polymer, polymeric resins, acrylic ester polymers, polystyrene divinyl benzene, polymethyl methacrylate, polystyrene, styrene divinylbenzene), molecular sieves, nanotube-containing materials, ion exchange resins, fly ash, activated carbon, carbon nanotubes, charcoal, alumina nanoparticles, zeolites, porous alumina, porous minerals, porous silica, silica nanoparticles, fumed silica, clays (such as aluminum phyllosilicates, bentonite, montmorillonite, ball clay, fuller's earth, kaolinite, attapulgite, hectorite, palygorskite, saponite, sepiolite), and metal organic frameworks (MOFs), or a combination thereof.

In one embodiment, the support particles are formed from a material selected from the consisting of polymeric materials, molecular sieves, zeolites, ion exchange resins, fly ash, activated carbon, carbon nanotubes, charcoal, alumina nanoparticles, porous alumina, porous silica, silica nanoparticles, fumed silica, clays, and metal organic frameworks (MOFs), or a combination thereof. More particular examples of the support particles include hydrogels, other polymeric supports such as cellulose or hypercrosslinked polymer, clays, charcoal, porous silica, molecular sieves, zeolites, and MOFs. It will be appreciated that other porous and non-porous scaffolds known to the person skilled in the art are also applicable, and can be readily determined by appropriate experimentation.

In some embodiments, the support particles are polymeric support particles. In one embodiment, the polymeric support particles comprise a hydrogel, hypercrosslinked polymer or a cellulose material, or a combination thereof.

### Cellulose Material Supports

In one embodiment, the support particles comprise a cellulose material. As used herein, the term “cellulose material” refers to a support that comprises the polysaccharide cellulose or a derivative thereof as an organic component, which exhibits the ability to swell and retain within its structure absorbed liquid without dissolving. For example, wood is a form of cellulose, with cellulose being the chief substance composing the cell walls or woody part of plants. In another example, carboxymethyl cellulose is a cellulose derivative with carboxymethyl groups bound to some of the hydroxyl groups of the glucopyranose monomers that make up the cellulose backbone. In one embodiment, the cellulose material is a wood based material or a synthetic cellulose material, or a combination thereof.

In one embodiment, there is provided an acidic gas absorbent particulate for capture of acidic gas, comprising cellulose material particles incorporating one or more acidic gas absorbents and a hydrophobe physically absorbed on or within the cellulose material particles.

In some embodiments, the cellulose material is a wood based material. The wood based material may be selected from the group consisting of saw dust, wood flour, wood dust or sander fines, or a combination thereof. In one embodiment, the wood based material is saw dust, wood flour, or wood dust. Saw dust is a particulate by-product or waste of woodworking operations, such as sawing. Wood flour is a pulverized dried wood particulate from either soft or hard wood waste. Wood dust is wood in a fine or powdered particulate condition. Sander fines are dust-like, minute wood particles. The wood based material may be a commercially available chemical spill kit.

In some embodiments, the synthetic cellulose material is selected from the group consisting of methyl cellulose, hydroxyethyl methyl cellulose, hydroxypropyl methyl cellulose, hydroxyethyl cellulose, hydroxypropyl cellulose, and carboxymethyl cellulose, or a combination thereof.

It will be appreciated that the embodiments described herein in relation to the support particles generally, equally apply to the cellulose material support particles.

### Hydrogel Supports

In one embodiment, the support particles comprise hydrogel particles. The term “hydrogel” refers to a three-dimensional (3D) network of cross-linked hydrophilic polymers that can swell and hold a large amount of water and other liquids while maintaining the structure due to chemical or physical cross-linking of individual hydrophilic polymer chains. The hydrogel comprises a cross-linked hydrophilic polymer. The absorbed water/liquid is taken into the cross-linked hydrophilic polymeric matrix of the hydrogel through hydrogen bonding rather than being contained in pores from which the fluid could be eliminated by squeezing. Unlike other more complex inorganic scaffolds and supports, such as zeolites or metal organic frameworks (MOFs), after removing the solvent the hydrogel does not retain a measurable dry state porosity.

In one embodiment, there is provided an acidic gas absorbent particulate for capture of acidic gas, comprising hydrogel particles of cross-linked hydrophilic polymer, wherein the hydrogel particles incorporate one or more acidic gas absorbents and comprise a hydrophobe physically absorbed on or within the hydrogel particles.

It will be appreciated that the embodiments described herein in relation to the support particles generally, equally apply to the hydrogel support particles. The hydrogel particles may have a roughened or textured surface which can provide an enhanced surface area which can facilitate the absorption of the liquid within the surface of the hydrogel, by increasing the surface area. The surface roughness may be provided by crushing/grinding the hydrogel into particles, wherein the particles comprise a roughened surface.

The hydrogel may be characterised by an elastic modulus. For example, the hydrogel may have an elastic modulus (in Pa) of at least about 0.1, 10, 30, 50, 100, 200, 500, 1,000, 2,000, 5,000, 8,000, 10,000 or 12,000. The hydrogel may have an elastic modulus (in Pa) of less than about 12,000, 10,000, 8,000, 5,000, 2,000, 1,000, 500, 200, 100, 50, 30, 10, or 0.1. The elastic modulus (in Pa) may be in a range provided by any two of these upper and/or lower values, for example between about 0.1 to 12,000, 100 to 5,000, or 2,000 to 5,000.

The elastic modulus may be determined by a number of suitable techniques, including using a rheometer, for example a HR-3 Discovery Hybrid Rheometer (TA Instruments). A Rheometer can be used to control shear stress or shear strain and/or apply extensional stress or extensional strain and thereby determine mechanical properties of a hydrogel including the modulus of elasticity thereof.

The hydrophilic polymer of the hydrogel is selected to provide suitable mechanical and chemical properties to the hydrogel. For example, in some embodiments, the hydrogel may need to be able to withstand various shear and stress environments, such as when in contact with the gaseous stream or atmosphere and/or dry or moist/humid environments. In some embodiments, the hydrogel may also need to withstand a wide temperature range, for example when undergoing thermal regeneration.

In some embodiments, the hydrogel may also need to be physically robust so that it can be introduced into various gas flowlines as a flow of particulate material or so that the particulate material can be provided in a packed bed with sufficient interstitial space between adjacent particles to allow a flow of gas or atmosphere therethrough. In some embodiments, the cross-linked hydrophilic polymer is also chemically inert. Accordingly, one or more of these properties may be provided by the appropriate selection of the hydrophilic polymer.

In some embodiments, the hydrogel comprises (in % w/w) at least about 0.01, 0.05, 0.1, 0.2, 0.5, 1, 2, 5, 10, 15, 20, 25, 30, 35, 40, 45, or 50 hydrophilic polymer based on the total weight of the hydrogel. In some embodiments, the hydrogel comprises (in % w/w) less than about 50, 45, 40, 35, 30, 25, 20, 15, 10, 5, 2, 1, 0.5, 0.2, 0.1, 0.05 or 0.01 hydrophilic polymer based on the total weight of the hydrogel. The % w/w of hydrophilic polymer may be in a range provided by any two of these upper and/or lower values, for example between about 0.05 to 50, 1 to 50, 0.05 to 25, 10 to 50, 10 to 40, or 30 to 50 based on the total weight of the hydrogel.

In some embodiments, the hydrophilic polymer has a weight average molecular weight (Mw in g/mol) of at least about 1,000, 5,000, 10,000, 50,000, 100,000, 150,000, 200,000, 250,000 or 500,000. In some embodiments, the hydrophilic polymer has a weight average molecular weight (Mw in g/mol) of less than about 500,000, 250,000, 200,000, 150,000, 100,000, 50,000, 10,000, 5,000 or 1,000. The molecular weight (Mw in g/mol) may be in a range provided by any two of these upper and/or lower values, for example between about 100 to 500,000, 1,000 to 250,000, 5,000 to 50,000, or 10,000 to 30,000. It will be appreciated that these weight average molecular weights are provided for the hydrophilic polymer prior to cross-linking. It will be appreciated that the weight average molecular weight of the hydrophilic polymer may vary depending on the type used to prepare the hydrogel. In one embodiment, the hydrophilic polymer may comprise a homopolymer or a copolymer. The weight average molecular weight can be determined using a variety of suitable techniques known to the person skilled in the art, for example gel permeation chromatography (GPC), size-exclusion chromatography (SEC) and light scattering. In one embodiment, the weight average molecular weight is determined by size-exclusion chromatography (SEC).

In one embodiment, the Mw is determined using size exclusion chromatography (SEC) by passing a solution of the hydrophilic polymer through a suitable column comprising a gel that separates the hydrophilic polymer based on molecular size (i.e. hydrodynamic volumes which can be correlated with molecular weight), with larger size molecules (larger Mw) eluting first followed by smaller size molecules (smaller Mw). This can be performed in a suitable organic solvent or in aqueous media. The Mw is typically determined against a series of known polymer standards or using molar mass sensitive detectors. Suitable protocols for determining molecular weight of the hydrophilic polymer are outlined in “Size-exclusion Chromatography of Polymers” Encyclopaedia of Analytical Chemistry, 2000, pp 8008-8034, incorporated herein by reference.

In some embodiments, the hydrogel comprises a cross-linked hydrophilic polymer selected from a cross-linked polyamine, a cross-linked polyacrylamide, a cross-linked polyacrylate, or a cross-linked polyacrylic acid, or copolymer thereof.

### Polyamines

In one embodiment, the hydrophilic polymer may comprise a polyamine, derivative or a copolymer thereof. As understood in the art, a polyamine is an organic compound having two or more amine groups (e.g. primary —NH₂, secondary —NHR, and/or tertiary —NR₂ amine groups). In one embodiment, there is provided an acidic gas absorbent particulate for capture of acidic gas, comprising hydrogel particles of cross-linked polyamine, wherein the hydrogel particles incorporate one or more acidic gas absorbents and comprise a hydrophobe physically absorbed on or within the hydrogel particles.

In some embodiments, the hydrophilic polymer may comprise a liner, branched, or dendritic polyamine, derivative or copolymer thereof. The polyamine, derivative or copolymer thereof can be cross-linked by one or more cross-linking agents described herein.

In one embodiment, the polyamine is a polyalkylenimine. The polyalkylenimine may be selected from the group consisting of polyethylenimine, polypropylenimine, and polyallylamine, derivatives or copolymers thereof. Suitable polyamines that can be used to form the hydrogel may include polyethylenimine, polypropylenimine, and polyallylamine. In one embodiment, the hydrophilic polymer is polyethylenimine or a copolymer thereof. By using a hydrogel comprising a cross-linked polyamine (such as polyethylenimine), the hydrogel comprises a plurality of primary and secondary amine functional groups which are capable of reacting and binding to an acidic gas (e.g. CO₂ or H₂S) upon contact with a gaseous stream or atmosphere comprising the acidic gas, thus enhancing absorption efficiency.

### Polyacrylamides

In some embodiments or examples, the hydrophilic polymer may comprise a polyacrylamide, derivative or copolymer thereof. As understood in the art, a polyacrylamide, derivative or copolymer is an organic compound having two or more acrylamide units. In some embodiments or examples, the polyacrylamide, derivative or copolymer thereof, may comprise copolymerisable hydrophilic monomers comprising at least two acrylamide or acrylamide derivatives to form a polyacrylamide, derivative or copolymer thereof. In another embodiment or example, the polyacrylamide copolymer, may comprise copolymerisable hydrophilic monomers comprising at least one acrylamide or acrylamide derivative and at least one carboxylic acid derivative to form a polyacrylamide copolymer.

The acrylamide derivative may be selected from N-alkyl, N-hydroxyalkyl, or N,N-dialkyl substituted acrylamide or methacrylamide. In some embodiments or examples, the polyacrylamide derivative may be selected from the group comprising N-acrylamide, methylacrylamide, N-ethylacrylamide, N-isopropylacrylamide (NiPAAm), N-octylacrylamide, N-cyclohexylacrylamide, N-methyl-N-ethylacrylamide, N-methylmethacrylamide, N-ethylmethacrylamide, N-isopropylmethacrylamide, N, N-dimethylacrylamide, N,N-diethylacrylamide, N,N-dimethylmethacrylamide, N, N-diethylmethacrylamide, N,N-dicyclohexylacrylamide, N-methyl-N-cyclohexylacrylamide, or combinations thereof. In an embodiment or example, the arylamide derivative may be selected from methacrylamide, dimethylacrylamide, N-isopropylacrylamide. N,N′-methylene-bis-acrylamide, N-2-hydroxyethylacrylamide, or combinations thereof.

The carboxylic acid derivative may be selected from the group comprising acrylic acid, methacrylic acid, methyl methacrylate, sodium acrylate, potassium acrylate, sodium methacrylate, potassium methacrylate, 2-hydroxyethyl methacrylate (HEMA), or combinations thereof.

In one embodiment or example, the acrylamide or acrylamide derivatives used in the preparation of the polyacrylamide or polyacrylamide derivative may be the same.

In another embodiment or example, the acrylamide or acrylamide derivative used in the preparation of the polyacrylamide copolymer may be different. In yet another embodiment, at least one acrylamide or acrylamide derivative and at least one carboxylic acid derivative may be used in the preparation of the polyacrylamide copolymer.

In some embodiments or examples, the polyacrylamide, derivative, or copolymer thereof may be selected from the group comprising or consisting of polyacrylamide, poly(methacrylamide), poly(N-2-hydroxyethyl)acrylamide, poly(dimethylacrylamide), poly(ethylacrylamide), poly(diethylacrylamide), poly(isopropylacrylamide), poly(methylmethacrylamide), poly(ethylmethacrylamide), poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly (acrylamide-co-methylenebisacrylamide).

In some embodiments or examples, the polyacrylamide, derivative or copolymer thereof may be selected from the group comprising or consisting of polyacrylamide, poly(methacrylamide), poly(dimethylacrylamide), poly(isopropylacrylamide), poly(acrylamide-co-acrylic acid), poly(acrylic acid-co-maleic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly(acrylamide-co-methylenebisacrylamide). In some embodiments or examples, the polyacrylamide copolymer may be selected from the group comprising or consisting of poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly(acrylamide-co-methylenebisacrylamide).

In some embodiments, the polyacrylamide, derivative, or copolymer thereof is poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt, and poly(acrylamide-co-methylenebisacrylamide). In one embodiment, the polyacrylamide, derivative, or copolymer thereof is poly(acrylamide-co-acrylic acid).

In one embodiment, the polyacrylamide is selected from the group consisting of polyacrylamide, poly(dimethylacrylamide), poly(N-2-hydroxethyl)acrylamide, poly (2-hydroxy ethylacrylamide), poly(isopropylacrylamide), poly(acrylamide-co-acrylic acid), poly(acrylic acid-co-maleic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly(acrylamide-co-methylenebisacrylamide).

The polyacrylamide, derivative, or copolymer thereof can be cross-linked by one or more cross-linking agents as described herein, For example, the polyacrylamide may be cross-linked with N, N-methylenebisacrylamide or ethylene glycol dimethacrylate via a free-radical initiated vinyl polymerization mechanism. In one embodiment, the cross-linked hydrophilic polymer is poly(acrylamide-co-methylenebisacrylamide) or poly(acrylamide-co-ethyleneglycol dimethacrylate). The polyacrylamide, derivative, or copolymer thereof may also be cross-linked with an aldehyde, for example formaldehyde or glutaraldehyde.

In some embodiments, the hydrogel comprising cross-linked polyacrylamide, derivative, or copolymer thereof, may further comprise one or more metal salts. Suitable metal salts include sodium salts or potassium salts.

### Polyacrylates

In some embodiments or examples, the hydrophilic polymer may comprise a polyacrylate, derivative or copolymer thereof. As understood in the art, a polyacrylate, derivative or copolymer is an organic compound having two or more acrylate units. In some embodiments or examples, the polyacrylate, derivative or copolymer thereof, may comprise copolymerisable hydrophilic monomers comprising at least two acrylate or acrylate derivatives to form a polyacrylate, derivative or copolymer thereof.

The acrylate derivative may be selected from acrylate, sodium acrylate, potassium acrylate, methacrylate, sodium methacrylate, potassium methacrylate, methyl methacrylate, 2-hydroxyethyl methacrylate (HEMA), 2-hydroxyethyl acrylate (HEA), N-isopropylacrylamide, or combinations thereof.

In some embodiments, the polyacrylate, derivative or copolymer thereof may be selected from the group comprising or consisting of poly(2-hydroxyethyl methacrylate) (pHEMA), poly(2-hydroxyethyl acrylate) (pHEA), or poly(sodium acrylate). In one embodiment, the polyacrylate, derivative or copolymer thereof may be selected from the group comprising or consisting of poly(2-hydroxyethyl methacrylate) (pHEMA) or poly(2-hydroxyethyl acrylate) (pHEA). In one embodiment, the polyacrylate, derivative or copolymer thereof is poly(2-hydroxyethyl methacrylate) (pHEMA). In one embodiment, the polyacrylate, derivative or copolymer thereof is poly(2-hydroxyethyl acrylate) (pHEA).

In one embodiment, the polyacrylate is poly(2-hydroxyethylmethacrylate) or poly(2-hydroxyethyl acrylate).

### Polyacrylic Acids

In some embodiments or examples, the hydrophilic polymer may comprise a polyacrylic acid, derivative or copolymer thereof. As understood in the art, a polyacrylic acid, derivative or copolymer is an organic compound having two or more acrylic acid units. In some embodiments or examples, the polyacrylic acid, derivative or copolymer thereof, may comprise copolymerisable hydrophilic monomers comprising at least two acrylic acid or acrylic acid derivatives to form a polyacryclic acid, derivative or copolymer thereof.

The acrylic acid derivative may be selected from acrylic acid or methacrylic acid, In some embodiments, the polyacryclic acid, derivative or copolymer thereof may be poly(acrylic acid) or poly(methacrylic acid).

In some embodiments, the hydrogel comprises a cross-linked hydrophilic polymer selected from the group consisting of poly(methacrylamide), poly(dimethylacrylamide), poly(ethylacrylamide), poly(diethylacrylamide), poly(isopropylacrylamide), poly(methylmethacrylamide), poly(ethylmethacrylamide, polyacrylamide, poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly (acrylamide-co-methylenebisacrylamide), polyethylenimine, polypropylenimine, polyallylamine, poly(2-hydroxyethylmethacrylate) or poly(2-hydroxyethyl acrylate), or a derivative or copolymer thereof.

In some embodiments, the hydrogel comprises a cross-linked hydrophilic polymer selected from the group consisting of polyamine, polyacrylate, polyacrylic acid, polyacrylamide or polyacrylamide-co-acrylic acid, polyacrylamide-co-acrylic acid partial sodium salt, polyacrylamide-co-acrylic acid partial potassium salt, poly(acrylic acid-co-maleic acid), poly(N-isopropylacrylamide), polyethylene glycol, polyethyleneimine, polypropylenimine, polyallylamine and vinylpyrrolidone, or a derivative or copolymer thereof. Alternatively, the hydrogel may comprise cross-linked natural hydrophilic polymers, for example polysaccharides, chitin, polypeptide, alginate or cellulose. Other suitable cross-linked hydrophilic polymers are described herein, for example polyamines, polyacrylates, polyacrylic acids or polyacrylamides, derivatives or copolymers thereof.

### Cross-Linkers

The hydrogel comprises a cross-linked hydrophilic polymer. It will be understood that some degree of cross-linking of the hydrophilic polymer is required to form the hydrogel. The rigidity and elasticity of the hydrogel can be tailored by altering the degree of cross-linking. The cross-linker promotes the formation of the 3D polymeric network, making it insoluble. The insolubilized cross-linked polymeric network allows for the adoption and retention of water and other liquids. An overview of cross-linked hydrogels is discussed in Maitra et al., American Journal of Polymer Science, 2014, 4(2), 25-31, which is incorporated herein by reference.

As used herein, the term “cross-link, “cross-linked” or “cross-linking” refers to the formation of interactions within or between hydrogel-forming polymers which result in the formation of a three-dimensional matrix. i.e. a hydrogel. For example, a polyamine may be cross-linked by 1,3-butadiene diepoxide (BDDE) or triglycidyl trimethylolpropane ether (TTE or TMPTGE) to form a cross-linked polyamine hydrogel.

In some embodiments, the cross-linked hydrophilic polymer comprises about 0.01 mol % to about 50 mol % cross-linking agent. The cross-linked hydrophilic polymer may comprise at least about 0.01, 0.1, 1, 2, 5, 10, 15, 20, 25, 30, 35, 40, 45, or 50 mol % cross-linking agent. The cross-linked hydrophilic polymer may comprise less than about 50, 45, 40, 35, 30, 25, 20, 15, 10, 5, 2, 1, 0.1 or 0.01 mol % cross-linking agent. Combinations of these mol % values to form various ranges are also possible, for example the cross-linked hydrophilic polymer may comprise between about 0.01 mol % to about 50 mol %, about 0.01 mol % to about 20 mol %, or about 0.01 mol % to about 10 mol % cross-linking agent.

In some embodiments, the hydrogel comprises between about 1% w/w to about 40% w/w cross-linking agent based on the total weight of the hydrogel. In some embodiments, the hydrogel comprises at least about 1, 2, 3, 4, 5, 6, 8, 10, 15, 20, 25, 30, 35 or 40 w/w. % cross-linking agent based on the total weight of the hydrogel. In other embodiments, the hydrogel comprises less than about 40, 35, 30, 25, 20, 15, 20, 15, 10, 8, 6, 5, 3, 2, or 1% w/w cross-linking agent based on the total weight of the hydrogel. Combinations of these % w/w values to form various ranges are also possible, for example between about 1% w/w to about 40% w/w, or between about 10% w/w to about 30% w/w cross-linking agent based on the total weight of the hydrogel.

Accordingly, in some embodiments, the hydrogel comprises between about 0.05% w/w to about 50% w/w cross-linked hydrophilic polymer based on the total weight of the hydrogel. In some embodiments, the hydrogel comprises at least about 0.01, 0.05, 0.1, 0.2, 0.5, 1, 2, 5, 10, 15, 20, 25, 30, 35, 40, 45, or 50% w/w cross-linked hydrophilic polymer based on the total weight of the hydrogel. In other embodiments, the hydrogel comprises less than about 50, 45, 40, 35, 30, 25, 20, 15, 10, 5, 2, 1, 0.5, 0.2, 0.1, 0.05 or 0.01% w/w cross-linked hydrophilic polymer based on the total weight of the hydrogel. Combinations of these cross-linked hydrophilic polymer to form various ranges are also possible, for example the hydrogel comprises between about 0.01% w/w to about 50% w/w, about 0.05% w/w to about 50% w/w, about 1% w/w to about 50% w/w, about 0.05 wt. % to about 25% w/w, about 10% w/w to about 50% w/w, about 10% w/w to about 40 wt. %, or about 30% w/w to about 50% w/w cross-linked hydrophilic polymer based on the total weight of the hydrogel.

The swelling ability of the hydrogel may be dependent in part on the nature of the cross-linked hydrophilic polymer. For example, a hydrogel with long hydrophilic cross-links may swell more than an analogous cross-linked polymer network with shorter hydrophobic cross-links.

In some embodiments, the cross-linking agent is an epoxide (i.e. an epoxide cross-linker). For example, the epoxide can provide a bivalent or polyvalent linking group in the cross-linked hydrophilic polymer, which may comprise one or more hydroxyl groups arising from reaction of the epoxide groups with the hydrophilic polymer. In some embodiments, the cross-linking agent comprises at least 1, 2, 3, 4 or 5 epoxides. In some embodiments, the cross-linking agent comprises 2 epoxides. In one embodiment, the cross-linking agent is an epoxide. In one embodiment the epoxide is a diepoxide (e.g. comprises 2 epoxide groups, for example BDDE). In one embodiment, the epoxide is a triepoxide (e.g. comprises 3 epoxide groups, for example TTE). In one embodiment, the cross-linking agent is 1,3-butadiene diepoxide (BDDE) or triglycidyl trimethylolpropane ether (TTE or TMPTGE). In some embodiments, the hydrogel comprises a cross-linked polyamine or copolymer thereof. In some embodiments, the hydrogel comprises a cross-linked polyacrylamide or co-polymer thereof. In some embodiments, the hydrogel comprises a cross-linked polyamine or a cross-linked polyacrylamide, or copolymers thereof.

The cross-linking agent may be selected from the group consisting of triglycidyl trimethylolpropane ether (TTE or TMPTGE) (also referred to as trimethylolpropane triglycidyl ether), diglycidyl ether, Resorcinol diglycidyl ether (CAS Number: 101-90-6), Bisphenol A diglycidyl ether, 1,3-Butadiene diepoxide, Diglycidyl 1,2-cyclohexanedicarboxylate, Diglycidyl hexahydrophthalate, Poly(ethylene glycol) diglycidyl ether average (<Mn 1000), Glycerol diglycidyl ether, 1,4-Butanediol diglycidyl ether, Bisphenol F diglycidyl ether, Bisphenol A propoxylate diglycidyl ether, Bisphenol A propoxylate diglycidyl ether PO/phenol 1, N,N-Diglycidyl-4-glycidyloxyaniline, N,N-Diglycidyl-4-glycidyloxyaniline, Poly(dimethylsiloxane), diglycidyl ether terminated (Mn<1000), Neopentyl glycol diglycidyl ether, 2,2-Bis[4-(glycidyloxy)phenyl]propane, 4,4′-Isopropylidenediphenol diglycidyl ether, BADGE, Bisphenol A diglycidyl ether, D.E.R.™ 332, Bis[4-(glycidyloxy)phenyl]methane, Tris(4-hydroxyphenyl)methane triglycidyl ether, Tris(2,3-epoxypropyl) isocyanurate, 4,4′-Methylenebis(2-methylcyclohexylamine).

Other suitable cross linking agents may also comprise one or more isothiocyanates, isocyanates, acyl azides, NHS esters, sulfonyl chlorides, aldehydes, glyoxals, epoxides, oxiranes, carbonates, aryl halides, imidoesters, carbodiimides, anhydrides, acrylates, acrylamides, diamines, and fluorophenyl ester groups.

The cross-linking agent may comprise an aldehyde group, for example at least one, two, or three aldehyde groups. For example, the cross-linking agent may be formaldehyde or glutaraldehyde. In one embodiment, the hydrophilic polymer is a polyacrylamide, derivative, or copolymer thereof cross-linked with an aldehyde, for example formaldehyde or glutaraldehyde.

The cross-linking agent may comprise two or more vinyl groups (—C═CH₂). For example, the cross-linking agent may be a divinyl cross-linking agent, such as N, N-methylenebisacrylamide or ethyleneglycol dimethacrylate. In some embodiments, the hydrophilic polymer is a polyacrylamide, derivative, or copolymer thereof, cross-linked with N,N-methylenebisacrylamide via a free-radical initiated vinyl polymerization mechanism, for example to form a poly(acrylamide-co-methylenebisacrylamide) hydrogel or poly(N-2-hydroxethyl)acrylamide hydrogel that is held together by covalent bonds.

In some embodiments, a free radical initiator and/or catalyst may be added to initiate/catalyse the radical polymerisation. Suitable catalysts include diamines, such as N,N,N′,N′-tetramethyldiaminomethane, N,N,N′,N′-tetraethylmethanediamine, N,N,N′,N′-tetramethyl-1,3-propanediamine, or N,N,N′,N′-tetramethyl-1,4-butanediamine. Suitable initiators include peroxysulfates, peroxyphosphates, peroxycarbonates, alkyl peroxides, acyl peroxides, hydroperoxides, ketone peroxides, peresters, azo compounds, azides, etc., e.g., diethyl peroxydicarbonate, ammonium persulfate, potassium persulfate, potassium peroxyphosphate, t-butyl peroxide, acetyl peroxide, t-butyl hydroperoxide, methyl ethyl ketone peroxide, dimethylperoxalate, azo-bis(isobutyronitrile), benzenesulfonylazide, 2-cyano-2-propyl-azo-formamide, azo-bisisobutyramidine dihydrochloride (or as free base), azobis-(N,N′-dimethyleneisobutyramidine-dihydrochloride (or as free base), and 4,4′-azo-bis(4-cyanopentanoic acid).

In some embodiments, the cross-linking agent is a diacrylate or a diacrylamide.

Other examples of suitable cross-linking agents include ethylene glycol dimethacrylate, piperazine diacrylamide, PEG diacrylate, ethyleneglycol dimethacrylate, diethyleneglycol diacrylate, triethyleneglycol diacrylate.

In one embodiment, the cross-linked hydrophilic polymer comprises poly(acrylamide-co-acrylic acid) or a partial sodium or potassium salt thereof, that is cross-linked with 1-ethyl-3-(3-dimethylaminopropyl)carbodiimide (EDC) and N-hydroxysuccinimide (NHS) and multifunctional amines.

### Hypercrosslinked Polymers

The support particles may comprise particles of hypercrosslinked polymer. In some embodiments, the hypercrosslinked polymer comprises a network of aryl groups linked by methylene (—CH₂—) bridging groups formed by Friedel-Crafts catalysed polymerization or Friedel-Crafts catalyzed post-polymerization cross-linking.

In one embodiment, there is provided an acidic gas absorbent particulate for capture of acidic gas, comprising particles of hypercrosslinked polymer comprises a network of aryl groups linked by methylene (—CH₂—) bridging groups formed by Friedel-Crafts catalysed polymerization or Friedel-Crafts catalyzed post-polymerization cross-linking, wherein the particles of hypercrosslinked polymer comprise absorbed liquid incorporating one or more acidic gas absorbents and a hydrophobe absorbed on or within the particles of hypercrosslinked polymer.

Generally, the aryl groups are individual benzene rings linked by two or more bridges of single methylene groups (—CH₂—) to two or more other benzene rings. In one set of embodiments the methylene bridging groups form covalent links between two adjacent aryl groups to form a six membered carbocyclic ring that is attached to the aryl rings. The methylene bridge may provide a six membered ring between adjacent aryl groups to provide, for example, 9,10-dihydroanthracene structure where the aryl groups are substituted benzene.

In some embodiments, the hypercrosslinked polymer is selected from the group consisting of: (i) a hypercrosslinked polymer of a substituted aryl monomer comprising at least two chloromethyl groups, formed by Friedel-Crafts catalysed polymerisation; and (ii) a hypercrosslinked polymer formed by Friedel-Crafts catalyzed post-polymerization cross-linking of a polymer containing aryl monomers substituted by a chloromethyl group; and (iii) a hypercrosslinked polymer formed by Friedel-Crafts catalyzed post-polymerization cross-linking of a polymer containing an aryl monomer with an external crosslinker.

In some embodiments, the hypercrosslinked polymer is formed by Friedel-Crafts catalyzed post-polymerization cross-linking of a polymer containing styrene with an external crosslinker, wherein the external cross-linker is selected from monochlorodimethyl ether and dimethyl formal. In some embodiments, the hypercrosslinked polymer is a polymer of dichloroxylene, formed by Friedel-Crafts catalyzed polymerization. In other embodiments, the hypercrosslinked polymer is hypercrosslinked polystyrene, formed by Friedel-Crafts catalyzed post-polymerization cross-linking of polystyrene.

In some embodiments, the methylene (—CH₂—) bridging groups of the hypercrosslinked polymer are formed by Friedel-Crafts catalyzed polymerization. In some such embodiments the hypercrosslinked polymer particles are formed by Friedel-Crafts catalysed condensation polymerization of an aryl monomer in the form of benzene comprising at least two chloromethyl (—CH₂Cl) substituents. In one example, the hypercrosslinked polymer is a polymer of dichloroxylene (e.g. para-dichloroxylene) formed by Friedel-Crafts catalyzed polymerization.

In a further embodiment the hypercrosslinked polymer is a polymer of a substituted aryl monomer comprising at least two chloromethyl groups, formed by Friedel-Crafts catalysed polymerisation.

In other embodiments, the methylene (—CH₂—) bridging groups of the hypercrosslinked polymer are formed in a Friedel-Crafts catalyzed post-polymerization cross-linking process. In some such embodiments the hypercrosslinked polymer is formed by post polymerisation crosslinking of polymers containing aryl monomers which are substituted with an internal electrophile, such as a chloromethyl group (—CH₂Cl), capable of reacting with other aryl groups via a Friedel-Crafts catalyzed reaction to form bridging methylene groups. Examples of suitable aryl monomers which are substituted in this manner include optionally substituted vinylbenzyl chloride monomers. Such monomers can be polymerized, optionally together with other styrenic monomers, by conventional free radical polymerization to form vinylbenzyl chloride polymers, including homopolymers and copolymers such as vinylbenzyl chloride-co-divinylbenzene copolymers and vinylbenzyl chloride-co-styrene copolymers. The corresponding hypercrosslinked polymers are then formed by post-polymerization crosslinking of the polymers in the presence of a Lewis acid.

In other embodiments the hypercrosslinked polymer is formed by post polymerisation Friedel-Crafts catalysed crosslinking of polymers containing aryl monomers with an external crosslinker. Examples of suitable aryl monomers include optionally substituted styrene monomers and in particular styrene. Such monomers can be polymerized by conventional free radical polymerization to form polymers, including homopolymers and copolymers such as styrene-divinyl benzene copolymers and styrene-co-vinylbenzyl chloride copolymers. The external cross-linker may be any difunctional Friedel-Crafts cross-linking agent capable of forming a methylene bridges between aryl rings in the presence of a Lewis acid. Preferred examples include monochlorodimethyl ether and dimethyl formal.

In one specific embodiment the hypercrosslinked polymer comprises a polymer network having a structure, or structural component, of at least one of formula I and formula II:

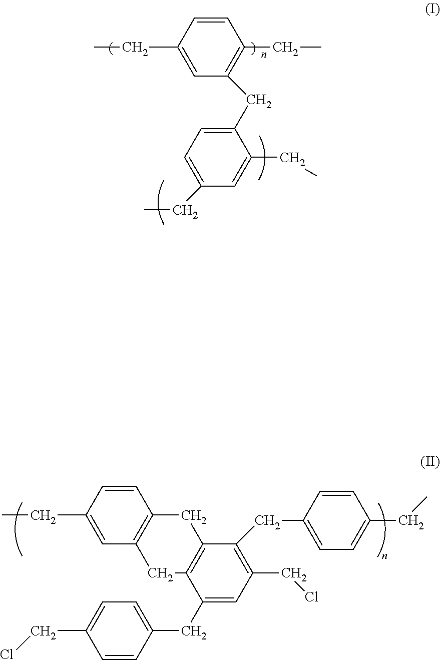

in which the number (n) of repeating units may be extremely high and indeed difficult to determine with accuracy.

### Absorbed Liquid

The support particles are capable of absorbing and retaining a liquid relative to its mass. In some embodiments, the support particles are generally capable of absorbing anywhere from at least 1 times its own weight in fluid (e.g. for porous molecular sieve supports which can absorb an amount of liquid but will not swell beyond its dry state pore volume) up to about 300 times its own weight in fluid (e.g. for a hydrogel based support). The surface area within the solid support particles may remain unchanged, increase or decrease depending on the degree of swelling. For example, a liquid can swell the a hydrogel support into a more open mobile structure with liquid-filled pores which may increase the accessibility of acidic gases (e.g. CO₂ or H₂S) to an acidic gas absorbent incorporated on or within the support particles (either as chemical moieties functionalised to the network forming the support particle or as reactive groups of an absorbed liquid therein). Depending on the type of support, the swelling capacity may vary, which essentially defines the swelling limit of the support particles.

As discussed above, the support particles may have a swelling capacity (i.e. is capable of absorbing liquid). The typical method to determine this is by taking a known weight of the dry support particles (e.g. dried hydrogel particles) and swelling in an excess of liquid for a specified period of time (typically 48 hours). After which time any excess liquid is removed by filtration and the support particles weight is recorded to determine the swelling ratio. The mass difference between the dry and swollen state of the support particles correspond to the amount of the absorbed liquid, which is then calculated as a grams of liquid per gram of support particles (g/g).

In some embodiments, the support particles may have swelling capacity (in (g/g)) of at least about 0.5, 1, 5, 10, 20, 30, 40, 50, 60, 70, 80, 90, 100, 150, or 200. In other embodiments, the support particles may have a swelling capacity (in (g/g)) of less than about 200, 150, 100, 90, 80, 70, 60, 50, 40, 30, 20, 10, 5, 1 or 0.5. The swelling capacity may be a range provided by any two of these upper and/or lower values, for example the support particles may have a swelling capacity (in (g/g)) of between about 1 to about 200, or between about 20 to about 100. The swelling capacity can also be provided as a percentage, for example a swelling capacity of 0.5 g/g equates to 50% (i.e. the particle swells 50%).

In one embodiment, the amount of liquid absorbed within the support particles does not exceed the swelling capacity of the support particles. According to some embodiments or examples, by not exceeding and/or operating below the support particles swelling capacity, the acidic gas absorbent particulate exhibits “dry” and “powdery” characteristics and is capable of flowing, even with the presence of liquid absorbed therein. By ensuring that the amount of absorbed liquid, and any moisture from the gaseous stream that may also be absorbed when in use, is at or near the particles swelling capacity whilst not exceeding the same, the amount of liquid within each particle can be maximised to allow for increased acidic gas absorption, whilst retaining the particulates “dry” and “powdery” characteristics.

In one embodiment, the support particles comprise absorbed liquid. The support particles are capable of absorbing and retaining the absorbed liquid within the support. The absorbed liquid may be strongly or weakly bound to the matrix network within the support particles or may be non-bound. The amount of absorbed liquid in the support particles may vary.

In some embodiments, the support particles may comprise (% w/w) at least about 0.5, 1, 5, 10, 20, 30, 40, 50, 60, 70, 80, 90, or 95 absorbed liquid based on the total weight of particulate (e.g. the weight of the support and any liquid absorbed therein). In some embodiments, the support particles may comprise (% w/w less than about 95, 90, 80, 70, 60, 50, 40, 30, 20, 10, 5, 1, or 0.5 absorbed liquid based on the total weight of the particulate. The amount of absorbed liquid within the support particles may be a range provided by any two of these upper and/or lower values, for example the support particles may comprise (% w/w between about 5 to about 95, between about 10 to about 95 or between about 40 to about 95 of absorbed liquid based on the total weight of the particulate.

In some embodiments, the weight ratio % of absorbed liquid to support particles in the acidic gas absorbent particulate may be at least about 1:5, 1:4, 1:3, 1:2, 1:1, 1.5:1, 2:1, 2:5:1, 3:1, 3.5:1, 4:1, 4.5:1 or 5:1. In some embodiments, the ratio the weight ratio % of absorbed liquid to support particles in the acidic gas absorbent particulate may be less than about 5:1, 4.5:1, 4:1, 3.5:1, 3:1, 2.5:1, 2:1, 1.5:1, 1:1, 1:2, 1:3, 1:4 or 1:5. The weight ratio % of absorbed liquid to support particles may be a range provided by any two of these upper and/or lower values, for example the between about 1:1 to about 5:1.

In one embodiment, the weight ratio % of absorbed liquid to support particles in the acidic gas absorbent particulate may be between 1:1 to about 5:1. According to some embodiments or examples, this ratio may provide one or more advantages, including maximising the amount of reactive functional groups for capture of the acidic gas (e.g. where the absorbed liquid comprises the acidic gas absorbent, such as an alkanolamine comprising amine reactive groups, that bind CO₂ via formation of carbamic acid) present within the particulate whilst maintaining the powdery “dry” characteristics of the support particles, which allows them to flow for example in a fluidised bed reactor.

The absorbed liquid may have low volatility. For example, the absorbed liquid may have a boiling point (in ° C.) of at least about 100, 120, 140, 160, 200, 220, 240, 260, 280, or 300. The absorbed liquid may have a boiling point (in ° C.) of less than about 300, 280, 260, 240, 220, 200, 160, 140, 120, or 100° C. The boiling point may be range provided by any two of these upper and/or lower values, for example between about 100° C. to about 300° C.

The absorbed liquid may be water, anon-aqueous solvent, or a mixture thereof. Suitable non-aqueous solvents include glycols such as monoethylene glycol (MEG), and glycerol. The absorbed liquid may also comprise or consist of the acidic gas absorbent as described herein.

### Acidic Gas Absorbents

The support particles incorporates one or more acidic gas absorbents for capturing acidic gas from a gaseous stream or atmosphere. Depending on the composition of the support particles, an acidic gas absorbent may be incorporated on or within the support particles as a liquid, including as the absorbed liquid described herein.

In one embodiment, the support particles comprise absorbed liquid, wherein the absorbed liquid comprises at least one acidic gas absorbent for incorporating an acidic gas absorbent with the support particles.

The acidic gas absorbent incorporated on or within the support particles as part of an absorbed liquid may be a physical absorbent for acidic gas or a chemical absorbent for acidic gas, or a mixture thereof. It will be appreciated that where the absorbed liquid comprises the acidic gas absorbent, the acidic gas absorbents are thus primarily or entirely liquid or dissolved components of the absorbed liquid absorbed on or within the support particles, and are not chemically grafted to the surface (interior and/or exterior) of the support particle. Of course, this does not preclude one or more additional acidic gas absorbents being chemically grafted to the surface of the support particle.

The term “physical absorbent” means an absorbent which absorbs the acidic gas from a gaseous stream or atmosphere by physical characteristics and not by means of a chemical reaction (e.g. do not chemically bind to the acidic gas but can dissolve it). Examples of physical absorbents include, but are not limited to, polyethylene glycols, alkyl ethers of polyethylene glycols and in particular dialkyl ethers such as dimethyl ethers of polyethylene glycol, N-methylpyrrolidone, propylene carbonate, imidazoles, methanol, sulfolane (tetrahydrothiophenedioxide) and estasolvan (tributyl phosphate). Specific examples of commercially available physical solvents include dimethyl ether (DEPG) of polyethylene glycol (UOP LLC; Des Plaines, IL) used in the SELEXOL process; methanol used in the RECTISOL® process (Lurgi AG; Frankfurt, Germany); RECTISOL® n-methyl-2-pyrrolidone (NMP) (Lurgi AG); and propylene carbonate (PC) used in the FLUOR SOLVENT process (Fluor Corp).

The term “chemical absorbent” means a chemical that preferentially absorbs to an acidic gas within a gaseous stream or atmosphere by means of a chemical reaction wherein a charge is transferred, for example by binding to the acidic gas via one or more functional groups (e.g. amines) present in chemical absorbent. Examples of chemical absorbents include, but are not limited to, amines including alkanolamines, alkylamines, and alkyloxyamines, piperidine and its derivatives, piperazines and its derivatives, pyridine and its derivatives, and mixtures thereof, as described herein.

Examples of suitable amines include primary amines such as monoethanolamine, ethylenediamine, 2-amino-2-methylpropanol, 2-amino-2-methyl-ethanolamine and benzylamine; secondary amines such as N-methylethanolamine, piperazine, piperidine and substituted piperidine, N-alkyl derivatives of 2-amino-1-propanol (AP), especially 2-N-methylamino-1-propanol (MAP), 2-N-methylamino-2-methyl-1-propanol (MAMP), as well as derivatives with two or more hydroxyl groups and/or ether derivatives, diethanolamine, diglycolamine and diisopropanolamine; and tertiary amines such as N-methyldiethanolamine, and amino acids such as taurine, sarcosine, alanine, 2-amino-2-methyl-1-propanol (AMP), 3-piperidinemethanol, 3-piperidineethanol, 2-piperidinemethanol, 2-piperidineethanol, N-piperidinemethanol, N-piperidineethanol, 2-methylaminoethanol, N,N-dimethylaminoethanol and 3-quinuclidinol. monoethanolamine, diethanolamine, aminoethylethanolamine, diglycolamine, piperazine, N-aminoethylpiperazine, N-(2-hydroxyethyl)piperazine and morpholine.

Mixtures of chemical and physical absorbents include mixtures of alkanolamines and sulfolane such as diisopropanolamine (DIPA) and sulfolane, N-methyldiethanol-amine (MDEA) and sulfolane or at least one of MEA and DEA and sulfolane.

In one embodiment, the absorbed liquid comprising the acidic gas absorbent comprises a chemical absorbent or mixture of physical and chemical absorbent. The acidic gas absorbent preferably comprises an amine selected from primary amines, secondary amines, tertiary amines and mixtures thereof. In one embodiment, there is provided an acidic gas absorbent particulate for capture of acidic gas comprising support particles, wherein the support particles contain absorbed liquid comprising an acidic gas absorbent, and a hydrophobe physically absorbed on or within the support particles.

The absorbed liquid may comprise a high proportion of physical and/or chemical absorbent. In one embodiment, the absorbed liquid may comprise at least about 30, 40, 50, 60, 70, 80 or 90% w/w of the acidic gas absorbent. In one embodiment, the absorbed liquid may comprise at least 50% w/w of the acidic gas absorbent. The acidic gas absorbent may be selected from physical absorbents for acidic gas, chemical absorbents for acidic gas and mixtures thereof. Indeed, the absorbed liquid may be entirely acidic gas absorbent selected from physical absorbents for acidic gas, chemical absorbents for acidic gas and mixtures thereof.

In one embodiment, the physical acidic gas absorbent selected from the group consisting of methanol, dialkyl ether of polyethylene glycols, N-methyl-2-pyrrolidone, propylene carbonate, sulfolane, N-acetylmorpholine, N-formylmorpholine, alkanolpyridines and 1,3-dimethyl-3,4,5,6-tetrahydro-2(1H)-pyrimidinone.

In one embodiment, the chemical acidic gas absorbent is an amine, for example a primary, secondary, or tertiary amine, or mixture thereof. The amine may be selected from the group consisting of monoethanolamine, ethylenediamine, 2-amino-2-methyl-1-propanol, 2-amino-2-methyl-ethanolamine, benzylamine, aminomethylpyridine, N-methylethanolamine, 2-(2-aminoethoxy)ethanol, amino-2-propanol, piperazine, piperidine, substituted piperidine, 3-piperidinemethanol, 3-piperidine ethanol, 2-piperidinemethanol, 2-piperidineethanol, diethanolamine, diglycolamine, diisopropanolamine, N-methyldiethanolamine, N-piperidinemethanol, N-piperidine, N,N-dimethylaminoethanol and 3-quinuclidinol and combinations thereof. In one embodiment, the amine is one or more of monoethanolamine, diethanolamine and N-methyldiethanolamine.

The amines may be solid or liquid at ambient temperature and ambient pressure and where solid they can be dissolved in a suitable carrier liquid, which may itself be a chemical acidic gas absorbent or physical acidic gas absorbent, forming a component of the absorbed liquid within the support particles. In one embodiment, the acidic gas absorbent, whether amine or otherwise, is selected from acidic gas absorbents which are liquid at ambient temperature and ambient pressure.

In one embodiment, the absorbed liquid comprises a mixture of chemical and physical absorbents, such as mixtures of alkanolamines and sulfolane such as diisopropanolamine (DIPA) and sulfolane, N-methyldiethanol-amine (MDEA) and sulfolane or at least one of MEA and DEA and sulfolane.

Alternatively or additionally, an acidic gas absorbent may be incorporated on or within the support as one or more chemical moieties functionalised (e.g. covalently bound/chemically grafted) to the network forming the support particle. For example, the support particles may be cross-linked polyethylenimine (PEI) hydrogel particles, wherein the cross-linked network comprises a plurality of primary and secondary amine functional groups which are capable of reacting and binding to an acidic gas (e.g. CO₂ or H₂S) upon contact with a gaseous stream.

### Hydrophobes

By absorbing a hydrophobe on or within the support particles, a reduced water uptake during acidic gas capture whilst retaining both good acidic gas absorption properties can be achieved. In particular, it has been surprisingly found that the acidic gas absorbent particulate surprisingly remains “dry” and flowable which allows it to be introduced into gas pipelines such as for use in in-line post combustion CO₂ capture from flue gas, despite the presence of the hydrophobe (which in some cases may be comprise a viscous material, such as silicone oil or paraffin wax).

The use of hydrophobe was also not expected to improve absorption of acidic gas when the surface and/or internal structure of the support particles is substantially covered or even completely filled (i.e. blocked) with hydrophobe. However, despite the presence of a hydrophobe barrier on the surface of the support particles, in some cases the uptake of acidic gas within the support particles (i.e. capture) increased and water uptake reduced compared to non-hydrophobe containing particles.

As used herein, the term “hydrophobe” refers to a molecule which, when absorbed (e.g. physically absorbed) on or within the support particles, renders the particles substantially hydrophobic in such a manner that it is able to repel water from being taken up within the particles, for example during CO₂ capture from a gaseous stream or atmosphere. For example, the hydrophobe may comprise a surfactant (e.g. SDS) having one or more polar groups that interact with the surface of the support particles (i.e. absorb on the surface of the particles) and one or more hydrophobic groups that extend away from the surface forming a hydrophobic surface coating. While prior to absorption, the surfactant is understood be amphiphilic: meaning they contain both hydrophobic groups (e.g. non-polar tails) and hydrophilic groups (e.g. polar head groups), once bound and absorbed on or within the support particles, the hydrophobic groups render the support particles substantially hydrophobic, i.e. a hydrophobe absorbed on or within the support particles.

In one embodiment, the hydrophobe is physically absorbed (i.e. physisorption) on or within the support particles. Physical absorption typically comprises weak Van der Waals forces between the hydrophobe and the support particles and is in most cases reversible in nature. This is very different to chemical absorption where any hydrophobe is covalently bound/chemically grafted/functionalised to one or more functional groups on the surface of the support particles, and is in most cases irreversible in nature. In other words, the physically absorbed hydrophobe is absorbed via non-covalent physical binding to the support particles as opposed to covalent bonding. Accordingly in one embodiment, there is provided an acidic gas absorbent particulate for capture of acidic gas comprising support particles incorporating one or more acidic gas absorbents, and a hydrophobe physically absorbed (i.e. physisorbed) on or within the support particles.

According to some embodiments or examples, by physically absorbing the hydrophobe on or within the support particles, the hydrophobe can be removed via one or more suitable washing steps (such as using a suitable organic solvent such as methanol), allowing for various types of hydrophobe to be used for a given support thus providing a versatile and flexible platform for acidic gas capture. It has also been surprisingly found that by physically absorbing the hydrophobe on or with the support particles, any reactive functional groups present on the network of the support that are capable of binding to acidic gas are not sacrificed which can lead to higher acidic gas capture rates compared to those which have hydrophobe chemically grafted thereon which sacrifice the presence of these binding sites.

The amount of hydrophobe required may vary depending on the type of hydrophobe and/or support, but nonetheless can be identified by suitable loading experiments. In one embodiment, the amount of hydrophobe absorbed on or within the support particles (% w/w) may be at least about 5, 10, 15, 20, 25, 30, 35, 40, 45 or 50 based on the total weight of the acidic gas absorbent (i.e. based on the total weight of the support particles, absorbed hydrophobe and any absorbed liquid/acidic gas absorbent). In one embodiment, the amount of hydrophobe absorbed on or within the support particles (% w/w) may be less than 50, 45, 40, 35, 30, 25, 20, 15, 10 or 5 based on the total weight of the acidic gas absorbent. The amount of hydrophobe absorbed on or within the support particles may be a range provided by any two of these upper and/or lower values, for example between about 5 to about 30, between about 5 to about 20, or between about 5 to about 15. In one embodiment, the amount of hydrophobe absorbed on or within the support particles (% w/w) may be between about 5 to about 50 based on the total weight of the acidic gas absorbent.

In some embodiments, the weight ratio % of hydrophobe to support particles in the acidic gas absorbent particulate may be between about 1:20 to about 5:1. In some embodiments, the weight ratio % of hydrophobe to support particles in the acidic gas absorbent particulate may be less than about 10:1, 8:1, 5:1, 2:1, 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19 or 1:20. In some embodiments, the weight ratio % of hydrophobe to support particles in the acidic gas absorbent particulate may be at least about 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 5:1, 8:1 or 10:1. The weight ratio % of hydrophobe to support particles may be a range provided by any two of these upper and/or lower values, for example the between 1:20 to about 1:1, or between about 1:10 to about 1:1.

In one embodiment, the weight ratio % of hydrophobe to support particles in the acidic gas absorbent particulate may be between about 1:20 to about 1:1, or between about 1:10 to about 1:1. According to some embodiments or examples described herein, these ratios may provide one or more advantages, including maximising the water repelling properties of the acidic gas absorbent whilst maintaining the powdery “dry” characteristics of the support particles, which allows them to flow for example in a fluidised bed reactor.

In one embodiment, at least some of the hydrophobe is absorbed on or near the surface of the support particles as a surface coating.

The hydrophobe may be selected from any suitable molecule that, once absorbed on or within the support particles, is capable of rendering the particles substantially hydrophobic in such a manner that it is able to repel water from being taken up within the particles.

The hydrophobe may be a solid or liquid at ambient temperature and ambient pressure, and where solid they can be dissolved in a suitable organic solvent and/or melted into a liquid prior to absorption on or within the support particles.

The hydrophobe may be have a viscosity of between about 1 cP to about 10,000 cP when measured at 25° C. (ASTM D7042-04), for example between about 5 cP to about 500 cP. The use of a low viscosity hydrophobe may provide further advantages, such as providing a uniform hydrophobe coating on the surface of the support particles.

Where applicable, the hydrophobe may be dissolved or suspended in an organic solvent which can then be contacted with the support particles. The organic solvent can then be removed (e.g. via vacuum drying) to leave the hydrophobe absorbed on or within the support particles.

In some embodiments, the hydrophobe has a molecular weight of greater than 200 g/mol.

In one embodiment, the hydrophobe is a surfactant, oil, wax, alcohol, or a hydrophobe-functionalised amine, or a mixture thereof.

### Surfactants

The hydrophobe may comprise a surfactant. As used herein, the term “surfactant” refers to a compound that is amphiphilic: meaning a compound that contains both hydrophobic groups (e.g. non-polar tails) and hydrophilic groups (e.g. polar head groups). Therefore, a surfactant contains both a water-insoluble (i.e. hydrophobic/lipophilic) groups and a water-soluble (i.e. hydrophilic/lipophobic) groups. According to some embodiments or examples described herein, the one or more hydrophilic groups may physically absorb on the surface of the support particles, and the hydrophobic groups extend away from the surface forming a hydrophobic surface coating.

The surfactant has a hydrophobic-lipophilic balance (HLB), which is a measure of the degree to which the surfactant is hydrophilic or lipophilic (i.e. hydrophobic). In one embodiment, the surfactant has a HLB of at least about 0.5, 1, 2, 4, 6, 8, 10, 12, 14, 16, 18 or 20. In one embodiment the surfactant has a HLB of less than about 20, 18, 16, 14, 12, 10, 8, 6, 4, 2, 1 or 0.5. The HLB may be a range provided by any two of these upper and/or lower values, for example between about 0.5 to about 30, or between about 4 to about 16.

In one embodiment, the surfactant is an anionic surfactant or a non-ionic surfactant or a mixture thereof.

As used herein, the term “anionic surfactant” refers to a surfactant having a negative change at the head group, such as a sulfate, sulfonate, phosphate or carboxylate. In one embodiment, the anionic surfactant is a fatty acid (i.e. a carboxylic acid with an aliphatic hydrophobic tail, which is either saturated or unsaturated).

According to some embodiments or examples, the fatty acid molecules physically absorb on the surface of the support particles via the polar carboxylic acid head group, with the hydrophobic tail groups extending away from the surface forming a hydrophobic surface coating.

In one embodiment, the anionic surfactant is a fatty acid selected from the group consisting of stearic acid, palmitic acid, oleic acid, linoleic acid, linolenic acid and arachidonic acid, or a mixture thereof. In one embodiment, the fatty acid is stearic acid or oleic acid, or a mixture thereof. In one embodiment, the fatty acid is stearic acid.

As used herein, the term “non-ionic surfactant” refers to a surfactant having polar head groups that are not electrically charged, and predominantly comprise covalently bonded oxygen-containing hydrophilic groups which are bonded to a hydrophobic group. In one embodiment, the non-ionic surfactant is selected from the group consisting of sorbitan fatty acid esters, polyoxyethylene sorbitan fatty acid esters, polyoxyethylene fatty acid esters, and polyethylene oxide fatty alcohol ethers, or a mixture thereof.

In one embodiment, the non-ionic surfactant is a sorbitan fatty acid ester selected from the group consisting of sorbitan monooleate (Span 80), sorbitan tristearate (Span 65), sorbitan monostearate (Span 60), sorbitan monopalmitate (Span 40) sorbitan monolaurate (Span 20) sorbitan monostearate.

In one embodiment, the non-ionic surfactant is a polyoxyethylene sorbitan fatty acid ester selected from the group consisting of polyoxyethylene sorbitan monooleate (Tween 80), polyoxyethylene sorbitan tristearate (Tween 65), polyoxyethylene sorbitan monostearate (Tween 60), polyoxyethylene sorbitan monopalmitate (Tween 40) polyoxyethylene sorbitan monolaurate (Tween 20) polyoxyethylene sorbitan monostearate.

### Oils

The hydrophobe may comprise an oil. As used herein, the term “oil” refers to water-insoluble material that is liquid at ambient temperature. In one embodiment, the oil may be selected from the group consisting of a hydrocarbon oil (e.g. alkanes or alkenes, from C₈-C₃₀, including paraffin oils, mineral oils, squalene, squalene, kerosene, vegetable oils such as soybean oil, linseed oil, canola oil, or other vegetable oil, etc.), polysiloxane oil (e.g. silicone oil) and other insoluble, low vapor pressure oils, as well as mixtures of these oils. In one embodiment, the hydrophobe is a hydrocarbon oil or a polysiloxane, or a mixture thereof.

In one embodiment, the hydrocarbon oil is selected from the group consisting of paraffin oil, mineral oil, squalene, or squalene, or a mixture thereof. In one embodiment, the polysiloxane oil is silicone oil or hydroxyl-terminated polydimethylsiloxane (Rain-X), or a mixture thereof. In one embodiment, the hydrophobe is a hydroxyl-terminated polydimethylsiloxane (Rain-X).

### Waxes

The hydrophobe may comprise a wax. As used herein, the term “wax” refers to an oil soluble solid material that typically has a melting point above ambient temperature, and characteristically comprise long aliphatic alkyl chains, although aromatic compounds may also be present. Waxes are typically insoluble in water but soluble in organic solvents. Natural waxes may contain unsaturated bonds and include various functional groups such as fatty acids, primary and secondary alcohols, ketones, aldehydes and fatty acid esters. Synthetic waxes often consist of homologous series of long-chain aliphatic hydrocarbons (alkanes or paraffins) that lack functional groups.

In one embodiment, the hydrophobe may comprise a wax selected from the group consisting of paraffin waxes, microcrystalline waxes, synthetic waxes, naturally occurring waxes such as vegetable and animal waxes, e.g. beeswax, carnauba wax and montan wax, and mixtures thereof.

In one embodiment, the hydrophobe may comprise petroleum derived wax, such as paraffin wax. Paraffin waxes are mixtures of saturated n- and iso-alkanes, naphthenes, and alkyl- and naphthene-substituted aromatic compounds. A typical alkane paraffin wax chemical composition comprises hydrocarbons with the general formula CₙH₂ₙ+2.

### Alcohols

The hydrophobe may comprise an alcohol, such as a long chain alcohol. In one embodiment, the hydrophobe may comprise a long-chain alcohol. Long-chain alcohols are of saturated fatty alcohols with the general formula CₙH₂ₙ₊₁—OH, wherein n is greater than 10, for example between 10 to 18. In one embodiment, the long chain alcohol is stearyl alcohol, CH₃(CH₂)₁₆CH₂OH.

### Hydrophobe Functionalised Amine

The hydrophobe may be functionalised onto a liquid amine which is absorbed on or within the support particles.

In one embodiment, the support particles may contain absorbed liquid comprising a hydrophobe-functionalised amine. The hydrophobe-functionalised amine comprises a hydrophobe covalently bonded to one or more amine groups of the amine.

In one embodiment, the support particles contain absorbed liquid comprising an amine and a hydrophobe covalently bonded to one or more amine groups of the amine

In one embodiment, the hydrophobe-functionalised amine is a reaction product of the amine group and a nitrogen-reactive compound comprising the hydrophobe.

As used herein, the term “nitrogen-reactive compound” refers to a compound having a functional group that is capable of reacting with a nitrogen group of an amine to form a covalent bond. The nitrogen-reactive compound comprises a nitrogen-reactive moiety and a hydrophobic moiety (i.e. a hydrophobe).

In one embodiment, the nitrogen-reactive compound comprising the hydrophobe is selected from the group consisting of epoxides, glycidyl ethers, glycidyl amines, alkyl halides, alkenyl halides, aralkyl halides, and alkyl sulfates.

In one embodiment, the nitrogen-reactive compound comprising the hydrophobe is a glycidyl ether, and the reaction product of the amine group and glycidyl ether comprises one or more of Formula 1a to 1d:

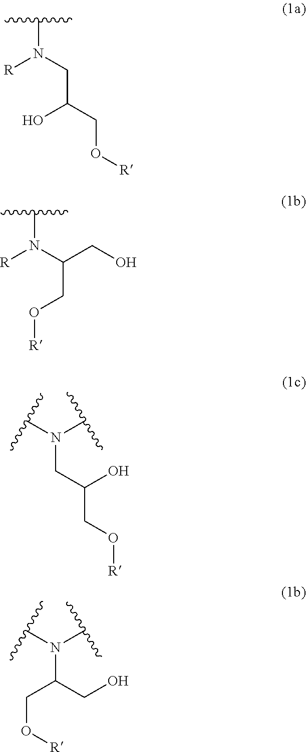

wherein
each R is independently selected from H,

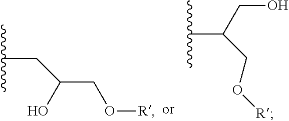

and
each R′ is independently an uninterrupted or interrupted and optionally substituted hydrocarbyl radical comprising between about 1 to about 30 carbon atoms; and
[symbol] represents an attachment point on the amine of the liquid amine.

In one embodiment, each R′ is independently selected from the group consisting of C₁₋₃₀alkyl, C₂₋₃₀alkenyl, C₂₋₃₀alkynyl, C₁₋₃₀alkoxy, C₃₋₃₀cycloalkyl, C₃₋₃₀aryl, C₁₋₃₀heteroalkyl or C₃₋₃₀heterocyclyl, each of which is uninterrupted or interrupted and optionally substituted.

In one embodiment, each R′ is independently selected from the group consisting of C₄₋₃₀alkyl, C₄₋₃₀alkenyl, C₄₋₃₀alkynyl, C₄₋₃₀alkoxy, C₄₋₃₀cycloalkyl, C₄₋₃₀aryl, C₄₋₃₀heteroalkyl or C₄₋₃₀heterocyclyl, each of which is uninterrupted or interrupted and optionally substituted.

In one embodiment, the glycidyl ether is an optionally substituted alkyl glycidyl ether. In one embodiment, the alkyl glycidyl ether is selected from the group consisting of C₁₋₃₀alkyl glycidyl ether, C₄₋₃₀alkyl glycidyl ether, C₆₋₃₀alkyl glycidyl ether, C₈₋₁₀alkyl glycidyl ether and C₁₀₋₃₀alkyl glycidyl ether, wherein each alkyl is uninterrupted or interrupted and optionally substituted.

In one embodiment, each R′ is independently selected from C₁₋₃₀alkyl, C₂₋₃₀alkyl, C₄₋₃₀alkyl, C₆₋₃₀alkyl, C₈₋₃₀alkyl or C₁₀₋₃₀alkyl, wherein each alkyl is uninterrupted or interrupted and optionally substituted.

In one embodiment, each R′ is independently C₁₋₃₀alkyl, wherein each alkyl is uninterrupted or interrupted and optionally substituted. In one embodiment, each R′ is independently C₂₋₃₀alkyl, wherein each alkyl is uninterrupted or interrupted and optionally substituted. In one embodiment, each R′ is independently C₄₋₃₀alkyl, wherein each alkyl is uninterrupted or interrupted and optionally substituted. In one embodiment, each R′ is independently C₆₋₃₀alkyl, wherein each alkyl is uninterrupted or interrupted and optionally substituted. In one embodiment, each R′ is independently C₈₋₃₀alkyl, wherein each alkyl is uninterrupted or interrupted and optionally substituted.

In one embodiment, each R′ is independently C₁₀₋₃₀alkyl, wherein each alkyl is uninterrupted or interrupted and optionally substituted. In one embodiment, each R′ is independently dodecyl or tetradecyl.

In one embodiment, the glycidyl ether is an optionally substituted alkyl glycidyl ether.

In one embodiment, the alkyl glycidyl ether is selected from the group consisting of C₁₋₃₀alkyl glycidyl ether, C₂₋₃₀alkyl, C₄₋₃₀alkyl glycidyl ether, C₆₋₃₀alkyl glycidyl ether, C₈₋₃₀alkyl glycidyl ether, and C₁₀₋₃₀alkyl glycidyl ether, wherein each alkyl is uninterrupted or interrupted and optionally substituted.

In one embodiment, the reaction product of the amine group and alkyl glycidyl ether comprises one or more of Formula 1a to 1d:

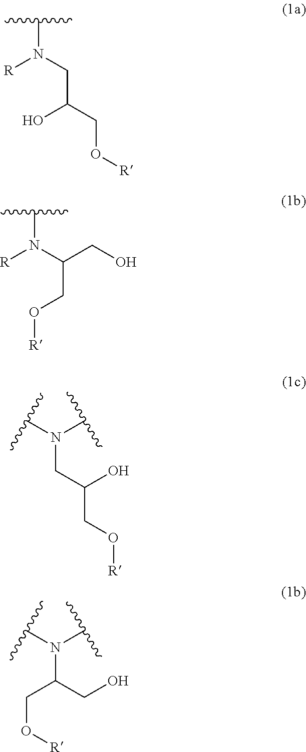

wherein
each R is independently selected from H,

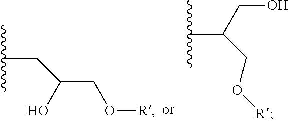

and
each R′ is independently selected from C₁₋₃₀alkyl, C₂₋₃₀alkyl, C₄₋₃₀alkyl, C₆₋₃₀alkyl, C₈₋₃₀alkyl or C₁₀₋₃₀alkyl, wherein each alkyl is uninterrupted or interrupted and optionally substituted; and
[symbol] represents an attachment point on the amine of the liquid amine.

The amine of the hydrophobe-functionalised amine may be a primary amine or a secondary amine. In some embodiments, the amine of the hydrophobe-functionalised amine may be selected from the group consisting of monoethanolamine, ethylenediamine, tetraethylene pentamine, 2-amino-2-methyl-1-propanol, diaminopropane, 2-amino-2-methyl-ethanolamine, benzylamine, aminomethylpyridine, N-methylethanolamine, 2-(2-aminoethoxy)ethanol, amino-2-propanol, piperazine, piperidine, substituted piperidine, 3-piperidinemethanol, 3-piperidine ethanol, 2-piperidinemethanol, 2-piperidineethanol, diethanolamine, diglycolamine, diisopropanolamine, N-methyldiethanolamine, N-piperidinemethanol, N-piperidine, N,N-dimethylaminoethanol and 3-quinuclidinol, or a combination thereof.

In some cases, following functionalising with the hydrophobe, the amine may retain one or more free reactive amines for capturing acidic gas. According to some embodiments or examples described herein, by retaining one or more free reactive amines following hydrophobe-functionalisation, the properties of the acidic gas absorbent particulate could be improved. For example, where the amine is a diamine, triamine, tetramine etc. (i.e. comprises two or more amine groups), having non-stoichiometric ratio of nitrogen-reactive compound to amine retains one or more free reactive amines following hydrophobe functionalisation which can improve the acidic gas capture performance of the acidic gas absorbent particulate. In this case, the hydrophobe may also be functioning as the acidic gas absorbent. Where the hydrophobe is chemically inert to acidic gas (e.g. silicone oil), it will be appreciated that the hydrophobe and acidic gas absorbent can be different. In one embodiment, the hydrophobe and acidic gas absorbent are different.

### Grafted Hydrophobes

For hydrogel particles comprising cross-linked polyamine, the hydrophobe may, in some instances, be covalently bound to one or more amine groups of the cross-linked polyamine forming the hydrogel particles. It will be appreciated that in this aspect, the hydrophobe forms part of the cross-linked polyamine and are typically distributed throughout the hydrogel particles. This chemical grafting of hydrophobes onto the cross-linked polyamine network is very different to the physical absorption (i.e. physisorption) of the hydrophobe on or within the surface of the hydrogel particles which are typically held by weaker physical forces such as Van der Waal forces, and represents a stronger attachment of the hydrophobe to the cross-linked polyamine network forming the hydrogel particles via covalent bonding with one or more amine groups.

The hydrophobe to be grafted may be selected from any suitable molecule that, once covalently bonded to the amine groups of the cross-linked polyamine, is capable of rendering the particles substantially hydrophobic in such a manner that it is able to repel water from being taken up within the particles. In one embodiment, the hydrophobe covalently bonded to the amine groups on the cross-linked polyamine is a reaction product of the amine group and a nitrogen-reactive compound comprising the hydrophobe. In one embodiment, the nitrogen-reactive compound comprising the hydrophobe is selected from the group consisting of glycidyl ethers, glycidyl amines, alkyl halides, alkenyl halides, aralkyl halides, and alkyl sulfates.

In one embodiment, the nitrogen-reactive compound comprising the hydrophobe is a glycidyl ether, and the reaction product of the amine group and glycidyl ether comprises one or more of Formula Ia to Id:

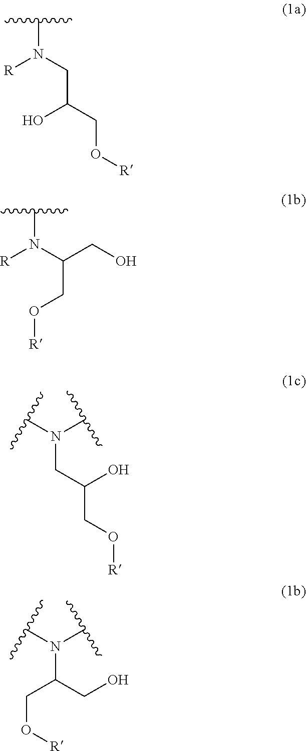

wherein
each R is independently selected from H,

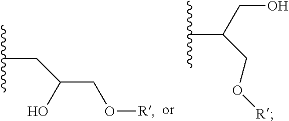

and
each R′ is independently an uninterrupted or interrupted and optionally substituted hydrocarbyl radical comprising between about 1 to about 30 carbon atoms; and
[symbol] represents an attachment point on the cross-linked polyamine or amine group, of the hydrogel.

In one embodiment, the reaction product of the amine group and glycidyl ether comprises a mixture of two or more of Formula Ia to Id.

In one embodiment, each R′ is independently selected from the group consisting of C₁₋₃₀alkyl, C₂₋₃₀alkenyl, C₂₋₃₀alkynyl, C₁₋₃₀alkoxy, C₃₋₃₀cycloalkyl, C₃₋₃₀aryl, C₁₋₃₀heteroalkyl or C₃₋₃₀heterocyclyl, each of which is uninterrupted or interrupted and optionally substituted.

In one embodiment, each R′ is independently selected from the group consisting of C₄₋₃₀alkyl, C₄₋₃₀alkenyl, C₄₋₃₀alkynyl, C₄₋₃₀alkoxy, C₄₋₃₀cycloalkyl, C₄₋₃₀aryl, C₄₋₃₀heteroalkyl or C₄₋₃₀heterocyclyl, each of which is uninterrupted or interrupted and optionally substituted.

In one embodiment, the glycidyl ether is an optionally substituted alkyl glycidyl ether. In one embodiment, the alkyl glycidyl ether is selected from the group consisting of C₁₋₃₀alkyl glycidyl ether, C₄₋₃₀alkyl glycidyl ether, C₆₋₃₀alkyl glycidyl ether, C₈₋₁₀alkyl glycidyl ether and C₁₀₋₃₀alkyl glycidyl ether, wherein each alkyl is uninterrupted or interrupted and optionally substituted.

In one embodiment, each R′ is independently selected from C₁₋₃₀alkyl, C₂₋₃₀alkyl, C₄₋₃₀alkyl, C₆₋₃₀alkyl, C₈₋₃₀alkyl or C₁₀₋₃₀alkyl, wherein each alkyl is uninterrupted or interrupted and optionally substituted.

In one embodiment, each R′ is independently C₁₋₃₀alkyl, wherein each alkyl is uninterrupted or interrupted and optionally substituted. In one embodiment, each R′ is independently C₂₋₃₀alkyl, wherein each alkyl is uninterrupted or interrupted and optionally substituted. In one embodiment, each R′ is independently C₄₋₃₀alkyl, wherein each alkyl is uninterrupted or interrupted and optionally substituted. In one embodiment, each R′ is independently C₆₋₃₀alkyl, wherein each alkyl is uninterrupted or interrupted and optionally substituted. In one embodiment, each R′ is independently C₈₋₃₀alkyl, wherein each alkyl is uninterrupted or interrupted and optionally substituted.

In one embodiment, each R′ is independently C₁₀₋₃₀alkyl, wherein each alkyl is uninterrupted or interrupted and optionally substituted.

In one embodiment, each R′ is independently dodecyl or tetradecyl.

In one embodiment, the reaction product of the amine group and alkyl glycidyl ether comprises one or more of Formula Ia to Id:

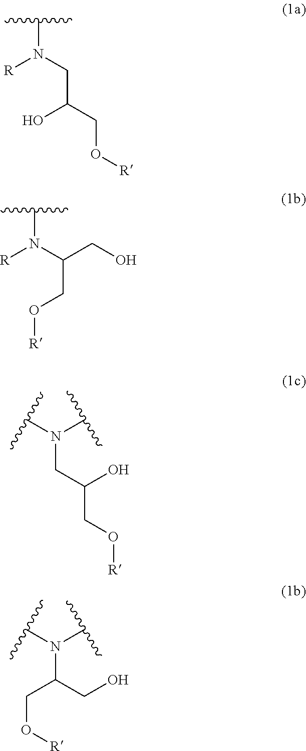

wherein
each R is independently selected from H,

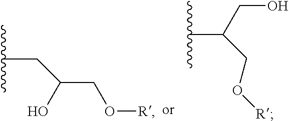

and
each R′ is independently selected from C₁₋₃₀alkyl, C₂₋₃₀alkyl, C₄₋₃₀alkyl, C₆₋₃₀alkyl, C₈₋₃₀alkyl or C₁₀₋₃₀alkyl, wherein each alkyl is uninterrupted or interrupted and optionally substituted; and
[symbol] represents an attachment point on the cross-linked polyamine or amine group, on the hydrogel.

Whilst the chemical grafting/covalent binding of the hydrophobe to the cross-linked polyamine hydrogel can provide some acidic gas uptake and water repelling properties, it has been surprisingly found that, according to some embodiments or examples described herein, physically absorbing hydrophobes on or within the support particles can provide much higher acidic gas capture rates, and in some cases double the uptake or even higher, as highlighted in the Examples.

### Process for Preparing Acidic Gas Absorbent Particulate

The present disclosure also provides a process for preparing the acidic gas absorbent particulate for capture of acidic gas. The process comprises contacting a hydrophobe with support particles incorporating one or more acidic gas absorbents under conditions effective to absorb the hydrophobe on or within the support particles.

The hydrophobe may be contacted with the support particles in a number of ways, including for example spraying the hydrophobe onto the support particles (e.g. spray-driven deposition) or simply mixing the support particles with the hydrophobe. The hydrophobe may be added to the support particles (e.g. sprayed or poured into a vessel comprising the support particles), or vice versa (e.g. the support particles may be added into a vessel comprising the hydrophobe).

To facilitate contact with the particles, the hydrophobe may be dispersed in an organic solvent to form a hydrophobe solution for contacting with the support particles. This is particularly useful for hydrophobes that are solid at ambient temperature, such as stearic acid or paraffin wax. Of course, hydrophobes that are liquid at ambient temperature may also be dispersed in an organic solvent. By dissolving/suspending the hydrophobe in a suitable organic solvent, the resulting hydrophobe solution can be easily contacted with the support particles, and in some embodiments can provide a uniform hydrophobe coating on the surface of the particles. Suitable organic solvents include any volatile organic solvent capable of dissolving/suspending the hydrophobe, such as ethyl acetate.

An advantage of dispersing the hydrophobe in an organic solvent, is that the resulting hydrophobe solution can be readily removed following contact with the support particles leaving the hydrophobe absorbed on or within the particles. In one embodiment, the hydrophobe solution is contacted with the support particles using spraying- or solvent-driven deposition.

A spray-driven deposition comprises spraying the hydrophobe solution onto the surface of the support particles as a fluid stream, which in some cases may be atomised using a suitable spray nozzle. Once the hydrophobe solution is sprayed onto the support particles, the organic solvent can be removed by drying (e.g. by vacuum or in an oven at ambient pressure) to provide the hydrophobe coated particles. A solvent-driven deposition process comprises dispersing the support particles in the hydrophobe solution to coat the particles. The organic solvent can then be removed by drying to provide the hydrophobe coated particles.

The hydrophobe and support particles may be contacted for a period of time effective for the hydrophobe to be absorbed on or within support particles. In one embodiment, the hydrophobe and support particles are contacted for a period of time (in minutes) of at least about 0.5, 1, 5, 10, 15, 20, 25, 30, 35, 40, 45, 50, 55, or 60. In one embodiment, the hydrophobe and support particles are contacted for a period of time (in minutes) of less than about 60, 55, 50, 45, 40, 35, 30, 25, 20, 15, 10, 5, 1, or 0.5. The contact time may be in a range provided by any two of these upper and/or lower values, for example the hydrophobe and support particles are contacted for a period of time (in minutes) of between about 5 to 60. It will be appreciate that the contact time may equally apply to a spraying time (e.g. or a spray-driven process) or a mixing time (e.g. for a solvent-driven process).

In some embodiments, the hydrophobe and support particles are combined in an amount to provide a weight ratio % of hydrophobe to support particles of less than about 10:1, 8:1, 5:1, 2:1, 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19 or 1:20. In some embodiments, the hydrophobe and support particles are combined in an amount to provide a weight ratio % of hydrophobe to support particles of at least about be at least about 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 5:1, 8:1 or 10:1. The weight ratio % of hydrophobe to support particles may be a range provided by any two of these upper and/or lower values, for example the between 1:20 to about 1:1, or between about 1:10 to about 1:1. According to some embodiments or examples described herein, this ratio may provide one or more advantages, including maximising the water repelling properties of the acidic gas absorbent whilst maintaining the powdery “dry” characteristics of the support particles, which allows them to flow for example in a fluidised bed reactor.

The process may further comprise the step of drying the support particles comprising the hydrophobe, for example to remove organic solvent following solvent- or spray-drive deposition of the hydrophobe solution onto the support particles. The drying conditions can be selected depending on the organic solvent used to dissolve/suspend the hydrophobe (e.g. about 80° C. to remove ethyl acetate).

In one embodiment, prior to contact with the hydrophobe, the support particles are contacted with a liquid under conditions effective to absorb the liquid within the support particles (e.g. the hydrophobe is contacted with support particles comprising absorbed liquid). The absorbed liquid may be any liquid as described herein, and is absorbed and retained within the support particles. In one embodiment, the liquid comprises an acidic gas absorbent selected from a physical absorbent for acidic gas or a chemical absorbent for acidic gas, or a mixture thereof.

The support particles and liquid may be contacted (i.e. combined or mixed) at a suitable temperature effective for the support to absorb and swell with the liquid. For example, the support particles may be contacted with a liquid (which may comprise the acidic gas absorbent) at a suitable temperature depending on the chemical and physical properties of the liquid and acidic gas absorbents. In cases where the liquid to be absorbed is viscous it may be desirable to heat the liquid to reduce viscosity and facilitate more rapid absorption and/or a higher loading of the absorbed liquid within the support particles.

In one embodiment, the acidic gas absorbents present in the particulate for capture of acidic gas are absorbed on or within the support particles as a liquid phase, and not chemically grafted to the support particles network.

In one embodiment, the liquid and support particles may be contacted for a period of time effective for the support to absorb and swell with the liquid. In one embodiment, the liquid and support particles are contacted for a period of time (in minutes) of at least about 5, 10, 15, 20, 25, 30, 35, 40, 45, 50, 55, or 60. In one embodiment, the liquid and support particles are contacted for a period of time (in minutes) of less than about 60, 55, 50, 45, 40, 35, 30, 25, 20, 15, or 10. The contact time may be in a range provided by any two of these upper and/or lower values, for example the liquid and support particles are contacted for a period of time (in minutes) of between about 5 to 60. Such swelling of the particles prior to contacting with the hydrophobe can increase the CO₂ capture efficiency as described herein.

While the amount of liquid contacted with the support particles may be selected to provide an optimal weight ratio % of absorbed liquid to support particles to obtain a powdery and dry particulate according to at least some embodiments or examples, in one embodiment, the support particles comprising the absorbed liquid are dried to remove excess liquid prior to contact with the hydrophobe. It will be appreciated that following such a drying step, the support particles still retain absorbed liquid (e.g. liquid absorbed within the pores or internal network structure of the support particles).

### Support Particles

The support particles can be commercially supplied, such as molecular sieves, zeolites, MOFs and the like. In this instance, the process may comprise the step of providing the support particles. The acidic gas absorbent may already be incorporated on or within the support particles, or may be added later (such as via absorbed liquid described herein). In some embodiments, the process comprises preparing the support particles.

### Cellulose Material

Cellulose material supports may be obtained from a suitable commercial supplier. Alternatively, the cellulose material may be obtained by shaving, sanding and/or milling a suitable cellulose material, such as a wood or plant product as described herein, to obtain the cellulose material particles. Various chemical spill kits and other cellulose material particulates may also be used as understood by the person skilled in the art. In one embodiment, where the support comprises cellulose material particles, the process may not require any grinding/crushing to obtain the acidic gas absorbent particulate.

### Hydrogel Supports

The process may comprise preparing hydrogel particles. Where the support particles comprise a hydrogel, the process may comprise grinding/crushing/blending the hydrogel to form the hydrogel particles prior to contact with the hydrophobe.

The hydrogel particles may be obtained from a suitable commercial supplier. Alternatively, the process may comprise preparing suitable hydrogel particles.

In some embodiments, the support particles comprise a hydrogel incorporating one or more acidic gas absorbents, and the process comprises:
mixing a solution comprising a hydrophilic polymer and a cross-linking agent under conditions effective to cross-link the hydrophilic polymer to form the hydrogel;
grinding/crushing the hydrogel to form hydrogel particles; and
contacting the hydrogel particles with the hydrophobe under conditions effective to absorb the hydrophobe on or within the hydrogel particles.

In one embodiment, the hydrogel particles are contacted with a liquid under conditions effective to absorb the liquid within the support particles prior to contacting with the hydrophobe.

As noted above, the process comprises the step of grinding/crushing the hydrogel to form a plurality of hydrogel particles prior to contacting with the hydrophobe under conditions effective to absorb the hydrophobe on or within the hydrogel particles. Any suitable technique can be used to ground the hydrogel, for example using a mortar and pestle, spatula or blender. The hydrogel may have a particle size as described herein.

Where hydrogel particles are used as the support, it will be appreciated that the absorption of the hydrophobe and/or liquid on or within the hydrogel may occur ex-situ i.e. after the hydrogel has been formed. Depending on the cross-linker being used to prepare the hydrogel, such ex-situ preparation may avoid any negative interaction between the hydrophobe and/or liquid and the cross-linker used to form the hydrogel. In an alternative embodiment, the absorption of the amine-hydrophobe and/or liquid on or within the hydrogel may occur during the formation of the hydrogel particles i.e. in-situ. For example, the hydrophilic polymer may be cross-linked in the presence of the hydrophobe and/or liquid to form the hydrogel particles comprising absorbed hydrophobe and/or liquid.

The hydrophilic polymer and cross-linking agent may be prepared as separate solutions and then mixed in any order to cross-link the hydrophilic polymer to form the hydrogel. Alternatively, the hydrophilic polymer and cross-linking agent may be prepared as a single solution (e.g. both dissolved in the same solution) which is then mixed to cross-link the hydrophilic polymer to form the hydrogel. Provided the hydrophilic polymer and cross-linking agent are mixed in solution, there is no limitation on how the individual components are prepared. The solution used to prepare the hydrogels may be an aqueous solution, such as water. Other suitable solutions may also include alcohols, such as methanol, ethanol, butanol, or isopropanol, which may be easier to remove.

The conditions effective to cross-link the hydrophilic polymer to form the hydrogel are described herein. The hydrophilic polymer and cross-linking agent may be mixed at a suitable temperature effective to cross-link the hydrophilic polymer to form the hydrogel. In one embodiment, the hydrophilic polymer and cross-linking agent may be mixed at a temperature of between about 10° C. to about 50° C. to cross-link the hydrophilic polymer to form the hydrogel. The hydrophilic polymer and cross-linking agent may be mixed at a temperature of at least about 10, 12, 15, 17, 20, 22, 25, 28, 30, 35, 40, 45 or 50° C. to cross-link the hydrophilic polymer to form the hydrogel. The hydrophilic polymer and cross-linking agent may be mixed at a temperature of less than about 50, 45, 40, 35, 30, 28, 25, 22, 20, 17, 15, 12 or 10° C. to cross-link the hydrophilic polymer to form the hydrogel. The mixing temperature may be in a range provide by any two of these upper and/or lower values. In some embodiments, the mixing temperature is about about 10, 12, 15, 17, 20, 22, 25, 28, 30, 35, 40, 45 or 50° C. to cross-link the hydrophilic polymer to form the hydrogel.

The hydrophilic polymer and cross-linking agent may be mixed for a period of time effective to cross-link the hydrophilic polymer to form the hydrogel. In one embodiment, the hydrophilic polymer and cross-linking agent are mixed for a period of time of about 5 min to about 60 min to cross-link the hydrophilic polymer to form the hydrogel. In some embodiments, the hydrophilic polymer and cross-linking agent are mixed for a period of time of at least about 5, 10, 15, 20, 25, 30, 35, 40, 45, 50, 55, or 60 min. of about 5 min to about 60 min to cross-link the hydrophilic polymer to form the hydrogel. The hydrophilic polymer and cross-linking agent may be mixed for a period of time of at less than about 60, 55, 50, 45, 40, 35, 30, 25, 20, 15, or 10 min to cross-link the hydrophilic polymer to form the hydrogel. The mixing time may be in a range provide by any two of these upper and/or lower values. In some embodiments, the mixing time is about 5, 10, 15, 20, 25, 30, 35, 40, 45, 50, 55, or 60 min to cross-link the hydrophilic polymer to form the hydrogel.

In some embodiments, one or more other additives may be added to the hydrophilic polymer and cross-linking agent, including for example an initiator and/or catalyst as described herein. For example, where the conditions effective to form the hydrogel comprise free-radical polymerization, it will be appreciated that an initiator (e.g. potassium persulfate) and/or catalyst (e.g. N,N,N′,N′-tetramethyldiaminomethane) can be added to initiate/catalyse the polymerisation and cross-linking of the hydrophilic polymer (e.g. PHEAA hydrogels). Alternatively, in other embodiments, the cross-linking of the hydrophilic polymer does not require the presence of an initiator and/or catalyst (e.g. cross-linked PEI hydrogels).

If required, prior to contacting the hydrophobe particles with the hydrophobe and/or liquid, the process may further comprise the step of drying the hydrogel particles to remove excess solution (e.g. the aqueous solution such as water used to mix the hydrophilic polymer and cross-linking agent). By doing so, this can increase and maximise the amount of hydrophobe and/or liquid that is absorbed on or within the hydrogel.

In one embodiment, the solution comprising the hydrophilic polymer comprises the acidic gas absorbent, as described herein.

In one embodiment, the hydrophobe is a hydrophobe-functionalised amine, and the process comprises mixing a liquid comprising an amine and a nitrogen reactive compound comprising a hydrophobe under conditions effective to covalent bind the hydrophobe to one or more amine groups of the amine prior to contact with the support particles.

### Hypercrosslinked Polymer Supports

The process may comprise preparing the hypercrosslinked polymer support. The hypercrosslinked polymer may comprise a network of aryl groups linked by methylene (—CH₂—) bridging groups formed by Friedel-Crafts catalysed polymerization or Friedel-Crafts catalyzed post-polymerization cross-linking, as described herein.

### Methods of Removing Acidic Gas

There is also provided method for removing an acidic gas from a gaseous stream or atmosphere.

In one embodiment, the method comprises contacting the gaseous stream or atmosphere with an acidic gas absorbent particulate as described herein, to absorb at least some of the acidic gas from the gaseous stream or atmosphere into the support particles.

Because the particulate is typically a dry, free flowing powder (despite the presence of absorbed hydrophobe and in some cases absorbed liquid), there is no bulk liquid phase present during the absorption. The gaseous stream or atmosphere may thus be contacted with the particulate in conventional gas-solid contact apparatus, such as a packed bed or fluidized bed of the particles. However, in some cases the acidic gas absorbent particulate contains absorbed liquid comprising the acidic gas absorbent (i.e. the acidic gas absorbent is incorporated on or within the swellable support particles as a liquid). In one embodiment, there is provided a method for removing an acidic gas from a gaseous stream or atmosphere, the method comprising contacting the gaseous stream or atmosphere with an acidic gas absorbent particulate as described herein to absorb at least some of the acidic gas from the gaseous stream or atmosphere into the absorbed liquid contained in the support particles.

The acidic gas absorbent particulate may be used in absorption of acidic gas in a range of industrial processes such as in removing acidic gas from pre-combustion processes such as from hydrocarbon gases, removal of acidic gas from combustion gases, reducing acidic gas produced in manufacture of products or the composition may be used in reducing the acidic gas content of ambient air. In one embodiment, the gaseous stream or atmosphere is selected from the group consisting of combustion flue gas, hydrocarbon gas mixture, emission from cement or steel production, biogas and ambient air.

The acidic gas absorbent particulate composition may be introduced into a gas flowline as a flow of particulate material. The particulate composition can be provided in a packed bed with sufficient interstitial space between adjacent particles to allow a flow of gas therethrough.

The acidic gas absorbent particulate will typically be used to absorb acidic gas by passing a gaseous stream or atmosphere comprising the acidic gas through a housing containing the particulate. The acidic gas is typically absorbed from a gaseous stream or atmosphere at a temperature and can be recovered from the particulate by changing the temperature and/or pressure, particularly by increasing the temperature.

Accordingly, in some embodiments, there is provided a method for capture of an acidic gas from a gaseous stream or atmosphere comprising: providing a chamber enclosing the acidic gas absorbent particulate disclosed herein; passing a flow of the gaseous stream or atmosphere comprising an acidic gas through the chamber and contacting the acidic gas absorbent particulate to absorb at least some of the acidic gas into the support particles; optionally heating the acidic gas absorbent particulate to a temperature effective to desorb the absorbed acidic gas from the support particles; and optionally flushing the desorbed acidic gas from the chamber. In some embodiments, there is provided a method for capture of an acidic gas from a gaseous stream or atmosphere comprising: providing a chamber enclosing the acidic gas absorbent particulate disclosed herein; passing a flow of the gaseous stream or atmosphere comprising an acidic gas through the chamber and contacting the acidic gas absorbent particulate to absorb at least some of the acidic gas into the absorbed liquid containing in the support particles; optionally heating the acidic gas absorbent particulate to a temperature effective to desorb the absorbed acidic gas from the support particles; and optionally flushing the desorbed acidic gas from the chamber.

The acidic gas may be absorbed into acidic gas absorbent particulate at a wide range of temperatures depending on the specific application and gaseous stream or atmosphere. In one embodiment, the absorption of acidic gas is carried out at a temperature (in ° C.) of less than about 100, 90, 80, 70 or 60, including ranges such as between about 60 to about 100, between about 60 to about 90, between about 60 to about 80, or between 60 to about 70. The acidic gas may be desorbed from the particulate by heating the particles for example using a heated gas stream. In one embodiment, the particles may be heated to a temperature (in ° C.) of at least about 80, 90, 100, 110, 120, 130 or 140, including ranges such as between about 80 to about 110, between about 80 to about 100, between about 80 to about 95, or between about 80 to 90.

The heating of the acidic gas absorbent particulate may be carried out using heated gas such as air, steam or using other heating methods such as thermal radiation or microwave heating. The desorbed acidic gas may be flushed from the housing with a gas such as air, nitrogen or even recycled CO₂.

In one embodiment, the method further comprises a regeneration recovery method to desorb the absorbed acidic gas from the acidic gas absorbent particulate.

### Gaseous Streams, Atmospheres and Acidic Gases

The acidic gas absorbents of the present disclosure can remove an acidic gas from a gaseous stream or atmosphere containing the acidic gas. The acidic gas may be carbon dioxide (CO₂) or hydrogen sulfide (H₂S) or a mixture thereof. In one specific embodiment, the acidic gas is CO₂.

The acidic gas may be a component of a natural gas, such as acid gas which is understood to be a natural gas mixture that contains significant quantities of acidic gases, namely, H₂S or CO₂. The acid gas may be sour gas, which is a specific type of acid gas that contains a significant amount of H₂S. In one embodiment, the acidic gas may be a contaminant in a hydrocarbon gas. Although the term ‘hydrocarbon gas’ general refers to natural gas, it will be appreciated by those skilled in the art that the term may equally apply to coal seam gas, associated gas, nonconventional gas, landfill gas, biogas, and flue gas. Alternatively, the acidic gas may be a component of lower acidic gas concentration gaseous streams or atmospheres, such as ambient air.

The gaseous stream or atmosphere may be any stream or atmosphere in which separation of one or more acidic gases from stream or atmosphere is desired. Examples of streams or atmospheres include product gas streams e.g. from coal gasification plants, reformers, precombustion gas streams, post-combustion gas streams (including in-line post combustion gas streams) such as flue gases, the exhaust streams from fossil-fuel burning power plants, sour natural gas, post-combustion, emissions from incinerators, industrial gas streams, exhaust gas from vehicles, exhaust gas from sealed environments such as submarines and the like. In one embodiment, the gaseous stream or atmosphere is selected from the group consisting of combustion flue gas, hydrocarbon gas mixture, emission from cement or steel production, biogas and ambient air.

In one embodiment, owing to the hydrophobe absorbed on or within the support particles, the gaseous stream or atmosphere does not need to be dried to remove moisture (H₂O) present in the gaseous stream prior to contacting with the acidic gas absorbent particulate.

In some embodiments, the gaseous stream or atmosphere may have an acidic gas concentration of less than about 200,000 parts per million (ppm). In one embodiment, the gaseous stream or atmosphere may have an acidic gas concentration of less than 150,000, 100,000, 75,000, 50,000, 25,000, 10,000, 5,000, 4,000, 1,000, 900, 800, 700, 600, 500, 400, 300, 200 or 100 ppm. In another embodiment, the gaseous stream or atmosphere may have an acidic gas concentration of between about 100 ppm to 100,000 ppm, about 100 ppm to about 10,000 ppm, or about 100 ppm to about 5,000 ppm. It will be understood that 1 ppm equates to 0.0001 vol. %. For example, a gaseous stream or atmosphere having an acidic gas concentration of less than about 100,000 ppm equates to 10.0 vol. % of acidic gas in the gaseous stream.

In some embodiments, the gaseous stream or atmosphere has no flow rate, e.g. 0 m³/hour. In some embodiments, or examples, the gaseous stream has a flow rate of between about 0.01 m³/hr to about 50,000 m³/hr. The flow rate may be at least 0.01, 0.05, 0.1, 0.5, 1, 5, 10, 20, 30, 40, 50, 60, 70, 80, 90, 100, 200, 300, 400, 500, 600, 700, 800, 900 1,000, 2,000, 3,000, 4,000, 5,000, 6,000, 7,000, 8,000, 9,000, 10,000, 15,000, 17,000, 20,000, 30,000, 40,000, or 50,000 cubic metres per hour (m³/hr). In some embodiments, the gaseous stream has a flow rate of less than 50,000, 40,000, 30,000, 20,000, 17,000, 15,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 5, 1, 0.5, 0.1, 0.05, or 0.01 m³/hr. The flow rate may be a range provided by any two of these upper and/or lower values, for example between about 0.01 m³/hour to about 1500 m³/hour, between about 5 m³/hour to about 1000 m³/hour, between about 10 m³/hour to about 500 m³/hour, between about 20 m³/hour to about 200 m³/hour, between about 60 m³/hour to about 1000 m³/hour, between about 0.01 m³/hr to about 5,000 m³/hr, about 5,000 to about 40,000 m³/hr, about 7,000 m³/hr to about 30,000 m³/hr, or about 10,000 m³/hr to about 20,000 m³/hour.

In some embodiments, increasing the flow rate of the gaseous stream or atmosphere as it contacts the acidic gas absorbent particulate leads to a faster rate of CO₂ absorption and capture in the acidic gas absorbent particulate. For industrial scale applications, the flow rate of the gaseous stream may be up to 1000 m³/hour. In some embodiments, the gaseous stream has no flow rate (e.g. an ambient atmosphere).

### Low CO₂ Concentration Gaseous Streams or Atmospheres

In one embodiment, the gaseous stream or atmosphere is a low CO₂ concentration gaseous stream or atmosphere. In one embodiment, the low CO₂ concentration gaseous stream or atmosphere is ambient air.

The acidic gas absorbent particulate of the present disclosure can remove CO₂ from low CO₂ concentration gaseous streams or atmospheres. For example, the method can remove CO₂ from a low CO₂ concentration gaseous stream or atmosphere. Examples of low concentration gaseous streams or atmospheres include the atmosphere (e.g. ambient air), ventilated air (e.g. air conditioning units and building ventilation), and partly closed systems which recycle breathing air (e.g. submarines or rebreathers). In some embodiments, the low CO₂ concentration gaseous stream or atmosphere may have a CO₂ concentration of less than about 200,000 parts per million (ppm). In one embodiment, the low CO₂ concentration gaseous stream or atmosphere may have a CO₂ concentration of less than 150,000, 100,000, 75,000, 50,000, 25,000, 10,000, 5,000, 4,000, 1,000, 900, 800, 700, 600, 500, 400, 300, 200 or 100 ppm. In another embodiment, the low CO₂ concentration gaseous stream or atmosphere may have a CO₂ concentration of between about 100 ppm to 100,000 ppm, about 100 ppm to about 10,000 ppm, about 100 ppm to about 5,000 ppm, about 100 ppm to about 1,000 ppm or about 100 ppm to about 500 ppm. In one embodiment, the low CO₂ concentration gaseous stream or atmosphere may have a CO₂ concentration of between about 200 ppm to about 500 μm, such as about 400 to 450 ppm.

In some embodiments, the low CO₂ concentration gaseous stream or atmosphere may have a CO₂ concentration of less than about 20, 15, 10, 7.5, 5, 2.5, 1, 0.5, 0.1, 0.09, 0.08, 0.07, 0.06, 0.05, 0.04, 0.03, 0.02 or 0.01 vol. %. In another embodiment, the low CO₂ concentration gaseous stream or atmosphere may have a CO₂ concentration of between about 0.01 vol. % to about 10 vol. %, about 0.01 vol. % to about 1 vol. %, about 0.01 vol. % to about 0.1 vol. %, or 0.01 vol. % to about 0.05 vol. %. In one embodiment, the low CO₂ concentration gaseous stream or atmosphere may have a CO₂ concentration of between about 0.02 vol. % to about 0.05 vol. %, such as about 0.04 vol. %.

In one embodiment, the low CO₂ concentration gaseous stream or atmosphere may have a CO₂ concentration the same as in ambient air (e.g. the atmosphere). Thus in one embodiment, the low CO₂ concentration gaseous stream or atmosphere may have a CO₂ concentration of about 400 ppm to 450 ppm CO₂, for example about 400 ppm to 415 ppm as in ambient air in most locations around the world. Accordingly, in one embodiment, the method is for direct air capture (DAC).

In one embodiment or example, the method is for direct air capture in indoor sealed environments (DACi). Thus, the CO₂ concentration gaseous stream or atmosphere may have a CO₂ concentration of up to 2,000 ppm. In one embodiment or example, the method is for direct air capture in external power plants (DACex). Thus, the CO₂ concentration gaseous stream or atmosphere may have a CO₂ concentration of about 3,000 ppm to about 150,000 ppm.

In one embodiment or example, the gaseous stream or atmosphere may comprise less than 100 ppm (i.e. 0.01 vol. %) hydrocarbon gas. In one embodiment, the gaseous stream or atmosphere may comprise less 10, 8, 5, 2, 1, 0.5, 0.1 or 0.01 vol. % hydrocarbon gas. In one embodiment, the gaseous stream or atmosphere may comprise less than 100 ppm (i.e. 0.01 vol. %) hydrocarbon gas. For example, the gaseous stream or atmosphere may comprise less than about 100, 75, 50, 25, 20, 15, 10, 5, 4, 3, or 2 ppm hydrocarbon gas. The term ‘hydrocarbon gas’ will be understood to refer to a gaseous mixture of hydrocarbon compounds including, but not limited to methane, ethane, ethylene, propane, and other C₃+ hydrocarbons. For example, it will be understood by a person skilled in the art that ambient air comprises methane as a minor impurity (e.g. 2 ppm/0.0002 vol. %), and that ambient air therefore may comprise less than 3 ppm hydrocarbon gas. The low CO₂ concentration gaseous stream or atmosphere may comprise predominantly of nitrogen makes up the major vol. % proportion in the gaseous stream. For example, the low CO₂ concentration gaseous stream or atmosphere may comprise at least about 50 vol. % nitrogen, for example at least about 70 vol. % nitrogen. In one embodiment, the low CO₂ concentration gaseous stream comprises about 78 vol. % nitrogen (e.g. ambient air).

The low CO₂ concentration gaseous stream or atmosphere may comprise an amount of water (e.g. the gaseous stream is damp/moist for example a humid gaseous stream). For example, the low CO₂ concentration gaseous stream or atmosphere may comprise between about 1 vol. % to about 10 vol. % water. Alternatively, the low CO₂ concentration gaseous stream or atmosphere may be a dry gaseous stream.

In some embodiments, the gaseous stream or atmosphere originates from a ventilation system, for example building ventilation or air conditioning. In other embodiments, the gaseous stream or atmosphere originates from a closed, or at least partially closed system, designed to recycle breathing gas, for example in a submarine, space craft, or aircraft. It will be appreciated that the acidic gas absorbent particulates of the present disclosure can also absorb CO₂ from gaseous streams or atmospheres with higher CO₂ concentrations, highlighting the versatility of the acidic gas absorbent particulates for a wide range of air capture applications. In an example, it is the ability of the acidic gas absorbent particulates to capture CO₂ at relatively low concentrations (e.g. 400 ppm) which the present inventors found particularly surprising.

The low CO₂ concentration gaseous stream or atmosphere is contacted with the acidic gas absorbent particulate. The gaseous stream or atmosphere may have a suitable flow rate to contact (e.g. pass through) the acidic gas absorbent particulate. Alternatively, the gaseous stream or atmosphere may come into contact with the acidic gas absorbent particulate without any back pressure or flow rate being applied (e.g. the gaseous stream may organically diffuse into the acidic gas absorbent particulate upon contact). In some embodiments, the gaseous stream or atmosphere may be an atmosphere surrounding the acidic gas absorbent particulate, for example a low CO₂ concentration atmosphere. In some embodiments, the gaseous stream or atmosphere passes through the acidic gas absorbent particulate (e.g. enters from a first side or face on the acidic gas absorbent particulate and exits from different side or face) or it may simply diffuse into the acidic gas absorbent particulate, for example when the acidic gas absorbent particulate is placed in an atmosphere, such as ambient air. As such, it will be understood that in some embodiments the gaseous stream does not need to be applied with a back pressure to essentially force the gaseous stream “through” the acidic gas absorbent particulate, although in some embodiments this may be desirable, such as when the acidic gas absorbent particulate is configured to a building ventilation system, for example. In one embodiment, the gaseous stream (e.g. atmosphere) diffuses into the acidic gas absorbent particulate upon contact with the acidic gas absorbent particulate.

The concentration of CO₂ in the gaseous stream or atmosphere can be measured by any suitable means, for example an isotopic analyser (e.g. using a G2201-i Isotopic Analyzer (PICARRO) and/or infrared spectrometer (e.g. an in-line calibrated cavity ring-down IR spectrometer). The concentration of CO₂ in the gaseous stream or atmosphere can be monitored by any suitable means, for example an SprintIR®-6S covering a range from 0-100% and K30 ambient sensor with a range of 0-1% CO₂.

### Methods for Acidic Gas Capture Release and Regeneration of Acidic Gas Absorbent Particulate

The acidic gas (e.g. CO₂) may be removed from the gaseous stream or atmosphere by being absorbed into an acidic gas absorbent particulate. In some embodiments, the acidic gas absorbent particulate is capable of absorbing between about 10 mg of acidic gas per g of acidic gas absorbent particulate (mg/g) to about 300 mg/g acidic gas. In some embodiments, the acidic gas absorbent particulate is capable of absorbing at least about 10, 20, 30, 40, 50, 60, 70, 80, 90, 100, 120, 150, 200, 250 or 300 mg/g acidic gas. In other embodiments, the acidic gas absorbent particulate is capable of absorbing less than about 300, 250, 200, 150, 120, 100, 90, 80, 70, 60, 50, 40, 30, 20 or 10 mg/g acidic gas. Combinations of these absorption values are possible, for example the acidic gas absorbent particulate is capable of absorbing between about 10 mg/g to about 80 mg/g acidic gas, between about 20 mg/g to about 70 mg/g acidic gas, or between about 100 mg/g to about 300 mg/g, or between about 200 mg/g to about 300 mg/g.

The gaseous stream or atmosphere contacts the acidic gas absorbent particulate (e.g. passes through a bed comprising the acidic gas absorbent particulate) resulting in an effluent gaseous stream following contact with the acidic gas absorbent particulate. As described above, before contact with the acidic gas absorbent particulate, the gaseous stream has an initial acidic gas concentration. After contact with the acidic gas absorbent particulate, the effluent gaseous stream has an effluent acidic gas concentration. The concentration of acidic gas in the effluent gaseous stream following contact with the acidic gas absorbent particulate may be measured to determine the concentration of acidic gas remaining in the gaseous stream. In one embodiment, the method further comprises measuring the concentration of acidic gas in an effluent gaseous stream or atmosphere following contact with the acidic gas absorbent particulate.

In some embodiments, overtime, the concentration of acidic gas in the effluent gaseous stream following contact with the acidic gas absorbent particulate may increase indicating reduced or no more acidic gas absorption is taking placed upon contact of the gaseous stream with the acidic gas absorbent particulate (e.g. indicating the acidic gas absorbent particulate is “saturated” (e.g. spent) and little to no more acidic gas absorption is occurring). This can act as an indicator to replace and/or regenerate the acidic gas absorbent particulate to continue acidic gas capture. The concentration of acidic gas in the effluent gaseous stream may be measured by any suitable means, for example using an in-line calibrated cavity ring-down IR spectrometer.

In some embodiments, the acidic gas absorbent particulate may be enclosed in a suitable chamber, wherein the chamber comprises one or more inlets through which the gaseous stream can flow to contact the acidic gas absorbent particulate enclosed therein, and one or more outlets through which the effluent stream can flow out from the chamber. Alternatively, the acidic gas absorbent particulate may be enclosed in a suitable chamber comprising one or more openings through which the gaseous stream can diffuse through to contact the acidic gas absorbent particulate enclosed therein. It will be appreciated that the chamber can take a number of forms provided the gaseous stream can access the acidic gas absorbent particulate. In one embodiment, the chamber may be a packed-bed column as described herein.

In some embodiments, the acidic gas absorbent particulate may be provided as a bed, wherein the contacting the gaseous stream with the acidic gas absorbent particulate comprises passing the gaseous stream or atmosphere through a bed comprising the acidic gas absorbent particulate. In one embodiment, the acidic gas absorbent particulate is provided as a packed-bed reactor.

In other embodiments, the contacting the gaseous stream with the acidic gas absorbent particulate comprises introducing a flow of the acidic gas absorbent particulate into the gaseous stream or atmosphere, for example using a fluidised bed reactor. Surprisingly and according to some embodiments or examples, an acidic gas absorbent particulate comprising a viscous hydrophobe (such as silicone oil) is still cable of flowing and retained dry and powdery characteristics.

The acidic gas absorbent particulate may be contacted with the gaseous stream for any suitable period of time, for example until the acidic gas absorbent particulate is spent and no more acidic gas absorption is occurring. In one embodiment, the acidic gas absorbent particulate is in contact with the gaseous stream until the concentration of acidic gas in the effluent gaseous stream is the same as the initial concentration of acidic gas of the gaseous stream. In some embodiments, the acidic gas absorbent particulate is in contact with the gases stream for at least about 5, 10, 30, 60 seconds, 10, 15, 20, 30, 45, 60 minutes, 2, 5, 10, 24, 48 or 36 hours.

In some embodiments, the acidic gas absorbent particulate provides various rates of acidic gas absorption. In one embodiment, the rate of acidic gas absorption can be measured by monitoring the acidic gas concentration of the effluent gaseous stream over time. For example, the concentration of acidic gas in the effluent gaseous stream may be less than about 50% of the initial acidic gas concentration after about 20 minutes of contact with the acidic gas absorbent particulate. In some examples, the concentration of acidic gas in the effluent gaseous stream may be less than about 5% of the initial acidic gas concentration after about 100 seconds of contact with the acidic gas absorbent particulate (in other words at least about 95% of acidic gas is removed from the gaseous stream after 100 seconds). Other rates of acidic gas absorption are also possible.

The acidic gas after absorption in the acidic gas absorbent particulate can be released by breaking the bonds between the acidic gas and the amine groups (e.g. the bond between the CO₂ and amine). This can be achieved through using temperature (through heating) or pressure (through vacuum). This may involve heating the column containing the acidic gas absorbent particulate or passing through a hot gas stream (e.g. steam) or hot air. Such desorption may be provided by any suitable environment capable of providing a heated environment (e.g. temperature) or a pressurised environment (e.g. through vacuum), or a combination thereof, in contact with or surrounding the acidic gas absorbent particulate which can desorb at least some of the acidic gas absorbed on or within the acidic gas absorbent particulate. Such desorption environment can operate in an “on” or “off” state. For example, once the concentration of acidic gas in the effluent gaseous stream following contact with the acidic gas absorbent particulate has increased to a level indicating reduced or no more acidic gas absorption is taking place, the desorption environment may be switched “on” to desorb acidic gas from the acidic gas absorbent particulate.

### Acidic Gas Absorption Apparatus

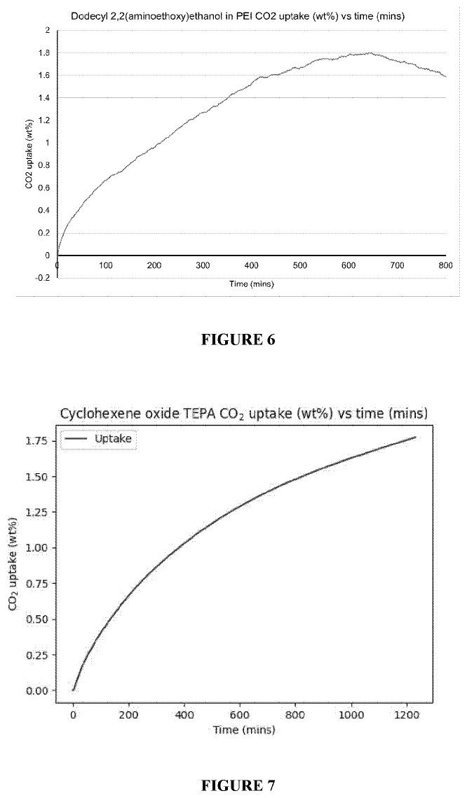

FIG. 5 depicts an apparatus 500 for performing the method for capture of an acidic gas from a gaseous stream or atmosphere, according to some embodiments or examples. Apparatus 500 includes first column 510 comprising chamber 511, gas inlet 512 and gas outlet 514, and second column 520 comprising chamber 521, gas inlet 522 and gas outlet 524. The chamber of each column is loaded with the acidic gas absorbent particulate 530, for example as a packed bed or fluidized bed. The acidic gas absorbent particulate 530 is a dry, free flowing powder of particles comprising an acid gas absorbent and hydrophobe as disclosed herein. Columns 510 and 520 are configured to be fed through their respective gas inlets with either gaseous stream or atmosphere 540 or flush gas 542 via gas manifolds 544 and 546. The gas effluent exiting the columns via their respective gas outlets are directed to either transfer line 560, for acidic gas lean gas, or transfer line 562, for acidic gas enriched gas, via gas manifolds 564 and 566.

In use, gaseous stream or atmosphere 540 is directed via manifolds 544, 546 to column 510 where it flows through chamber 511 and contacts the acidic gas absorbent particulate 530 therein. Gaseous stream or atmosphere 540 may, for example, contain CO₂ as the acidic gas to be captured. The acidic gas is absorbed into acidic gas absorbent particulate. The gas effluent leaving column 510 is thus depleted of at least a portion of the acidic gas, and is directed by gas manifolds 564, 566 to transfer line 560 which sends the acidic gas lean gas (treated gaseous stream or atmosphere 540) for further processing or atmospheric release.

After a period of time, the absorption capacity of acidic gas absorbent particulate 530 in column 510 will approach its maximum and the material must be regenerated to avoid unacceptable breakthrough of the acidic gas. Therefore, gaseous stream or atmosphere 540 is redirected via manifolds 544, 546 to column 520 where it flows through chamber 521 and contacts acidic gas absorbent particulate 530 therein. The gas effluent leaving column 520 is thus depleted of at least a portion of the acidic gas, and is directed by gas manifolds 564, 566 to transfer line 560.

While gaseous stream or atmosphere 540 is being processed in column 520, the composition 530 in column 510 is regenerated by heating the acidic gas absorbent particulate to a temperature sufficient to desorb the acidic gas from the particles. The desorbed acidic gas is then flushed from chamber 511 of column 510 with flush gas 542. The acidic gas absorbent particulate may be heated with flush gas 552, which is fed for contact with the composition at a suitably high temperature and/or by other conventional means of heating the particulate in a column. The gas effluent leaving column 510 is thus rich in acidic gas, and is directed by gas manifolds 564, 566 to transfer line 562 which sends the acidic gas enriched gas for storage or further processing. By switching the columns sequentially between absorption and desorption modes in this manner, acid gas 540 can be continuously processed to capture all or part of the acidic gas therefrom.

Accordingly, the disclosure also provides an acidic gas removal apparatus comprising a chamber enclosing an acidic gas absorbent particulate for capture of acidic gas from a gaseous stream or atmosphere disclosed herein, wherein the chamber brings the gaseous stream or atmosphere into contact with the support particles to absorb at least some of the acidic gas into the support particles.

In some embodiments, the chamber comprises an inlet through which the gaseous stream or atmosphere can flow to the support particles and an outlet through which the effluent gaseous stream or atmosphere can flow out from the support particles. The acidic gas absorbent particulate may be located between the inlet and outlet of the chamber.

In some embodiments or examples, the apparatus may comprise two or more chambers enclosing the acidic gas absorbent particulate in each chamber connected in parallel to the gaseous stream. The apparatus may comprise at least three chambers enclosing the acidic gas absorbent particulate in each chamber, wherein each chamber may be connected in parallel to the gaseous stream. The acidic gas absorbent particulate enclosed within the at least three chambers may be operated in different sections of the absorption and regeneration cycle to produce a continuous flow of the effluent gaseous stream.

Fluid flow is typically required to move the gaseous stream from the inlet of the chamber, across the acidic gas absorbent particulate enclosed and out of the chamber through the outlet. The fluid flow may be driven by at least one fluid flow device which drives a fluid flow from the inlet to the outlet of the absorption apparatus.

A variety of different fluid flow devices can be used. In some embodiments or examples, the fluid flow device comprises at least one fan or pump. In some embodiments, or examples, the flow rate of the gaseous stream entering through the inlet, across the acidic gas absorbent particulate, may be between about 0.01 m³/hr to about 50,000 m³/hr. The flow rate may be at least 0.01, 0.05, 0.1, 0.5, 1, 5, 10, 20, 30, 40, 50, 60, 70, 80, 90, 100, 200, 300, 400, 500, 600, 700, 800, 900 1,000, 2,000, 3,000, 4,000, 5,000, 6,000, 7,000, 8,000, 9,000, 10,000, 15,000, 17,000, 20,000, 30,000, 40,000, or 50,000 cubic metres per hour (m³/hr). In some embodiments, the gaseous stream has a flow rate of less than 50,000, 40,000, 30,000, 20,000, 17,000, 15,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 5, 1, 0.5, 0.1, 0.05, or 0.01 m³/hr. Combinations of these flow rates are also possible, for example between about 0.01 m³/hr to about 5,000 m³/hr, about 5,000 to about 40,000 m³/hr, about 7,000 m³/hr to about 30,000 m³/hr, or about 10,000 m³/hr to about 20,000 m³/hour. The flow rate of the gaseous stream through the chamber and across the acidic gas absorbent particulate may be achieved with substantially no back pressure measurable through or across the acidic gas absorbent particulate. In an alternate embodiment or example, pressure variance or suction may be used to drive fluid flow of the gaseous stream through the device. For industrial scale applications, the flow rate of the gaseous stream may be up to 1000 m³/hour.

The chamber(s) may have any suitable configuration. In some embodiments or examples, the chamber comprises an inlet at one end and an outlet at the opposite end. In an embodiment or example, a substrate, as described herein, can be located or otherwise packed within the chamber in a compacted manner to increase the surface area within that volume.

The apparatus may comprise a single or multiple chambers, wherein each chamber may enclose the acidic gas absorbent particulate, as described herein. In some embodiments or examples, the apparatus may comprise two or more chambers enclosing a acidic gas absorbent particulate in each chamber connected in parallel to the gaseous stream. In another embodiment or example, the apparatus may comprise at least three chambers enclosing the acidic gas absorbent particulate in each chamber, wherein each chamber may be connected in parallel to the gaseous stream. In some embodiments or examples, the acidic gas absorbent particulate enclosed within the at least three chambers may be operated in different sections of the absorption and regeneration cycle to produce a continuous flow of the effluent gaseous stream.

In some embodiments or examples, the method may be a cyclical method, where the steps of absorbing the acidic gas in the acidic gas absorbent particulate enclosed by the chamber and releasing the acidic gas through operation of at least one desorption arrangement in a repetitive cycle so to continuously produce the effluent gaseous stream. The cycle time may depend on configuration of the absorption apparatus, the configuration of the chamber(s), the type of desorption arrangement, the composition of the acidic gas absorbent particulate, breakthrough point, saturation point and characteristics of the acidic gas absorbent particulate, temperature, pressure and other process conditions. In some embodiments or examples, the cycle time may be about 10, 15, 20, 30, 45, 60 minutes, 2, 5, 10, 24, 48 or 36 hours.

In some embodiments or examples, the desorption arrangement can take any number of forms depending on whether heat and/or reduced pressure is being used. In some embodiments or examples, the apparatus is designed for pressure swing absorption, with desorption being achieved by reducing the pressure for example using a vacuum pump to evacuate the gas from around the chamber enclosing the acidic gas absorbent particulate. In other embodiments or examples, temperature swing absorption is undertaken to collect the acidic gas from the acidic gas absorbent particulate. This can be achieved using direct heating methods.

In some embodiments or examples, the desorption arrangement may comprise a temperature swing absorption arrangement where the acidic gas absorbent particulate is heated. For example, operating at least one desorption arrangement heats the acidic gas absorbent particulate to a temperature of between about 80 to 140° C.

The present disclosure provides a method where a gaseous stream or atmosphere containing a concentration of acidic gas is fed into absorptive contact with the acidic gas absorbent particulate, as described herein. After the acidic gas absorbent particulate is charged with an amount of the acidic gas, the desorption arrangement is activated forcing at least a portion of the acidic gas to be released from the acidic gas absorbent particulate. The desorbed acidic gas absorbent particulate can be collected using a secondary process.

In other words, the effluent gaseous stream or atmosphere from the outlet can flow to a variety of secondary processes. For example, for carbon dioxide capture, the absorption apparatus of the present disclosure can be integrated with a liquefier and/or dry ice pelletiser to provide dry ice on-demand. In another example, the absorption apparatus of the present disclosure can be integrated with a hydrogenation apparatus to convert carbon dioxide (CO₂) to methane. In yet another example, the absorption apparatus of the present disclosure may be used to absorb carbon dioxide (CO₂) and store it for use at a different time. This would be applicable in a green-house type environment where CO₂ is absorbed at a particular time and used at a different time. In yet another example, the absorption apparatus of the present disclosure may be particularly applicable for CO₂ in a confined space. For example, inside a submarine, space craft, air craft or other confined space like a room where the absorption apparatus would be used to remove CO₂, and the apparatus capable of absorbing and desorbing CO₂ in a continuous cycle.

The absorption apparatus of the present disclosure is advantageously compact and can be located much closer to end users, thereby allowing disruptive supply opportunities and better customer value.

In some embodiments, the chamber comprises a packed bed or fluidized bed of the particulate.

The present application claims priority from Australian Provisional Patent Application No. 2022903348 filed on 9 Nov. 2022, the entire contents of which are incorporated herein by reference.

### EXAMPLES

In order that the disclosure may be more clearly understood, particular embodiments of the invention are described in further detail below by reference to the following non-limiting experimental materials, methodologies and examples.

### Example 1: Fabrication of Polyethylenimine Hydrogel Particles (“PEI”)

To fabricate polyethylenimine hydrogel particles (“PEI Snow”), 9 g of PEI-25,000 aqueous solution with a mass concentration of 30.0 wt. % was added into a 20 mL plastic sample vial. Subsequently, 1 g of a methanol solution of 6 wt. % trimethylolpropane triglycidyl ether cross-linker with varying concentrations was also added into the same vial to initiate the PEI crosslinking at the ambient temperature. The crosslinking reaction terminated within 15 min depending on the amount of the cross-linker and eventually a bulk PEI gel was produced. Afterward, the PEI gel was vigorously ground using a glass stirring rod to obtain a snow-like material that had an average particle size of 200~300 μm. The powdery material was then rinsed by excessive amount of ethanol and distilled water to remove the methanol.

The PEI particles were then swollen in liquid diethanolamine (DEA) based on a weight ratio of PEI to DEA of 1:1.

### Example 2: Coating DEA Swollen PEI Particles with Silicone Oil

Silicone oil was coated on the swollen PEI particles either via spray- or solvent-driven deposition. The spray-driven process was conducted by spraying a solution of silicone oil dispersed in ethyl acetate onto the swollen PEI particles packed in a tray (10*10*3 mm) using a spray bottle with a squeeze trigger. Following the spray coating, the tray was allowed to be dried under ambient conditions overnight to remove the ethyl acetate. The silicone oil coated swollen PEI particles were then dried in an oven at 80° C. for 30 min prior to acidic gas capture testing.

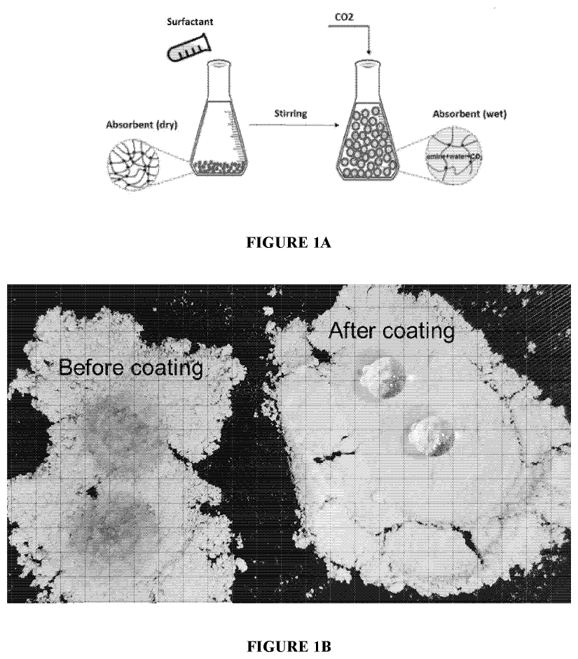

The solvent-driven deposition was carried out by mixing the swollen PEI particles in a solution of solution of silicone oil dispersed in ethyl acetate (see FIG. 1A) The resulting mixture was stirred to form a homogeneous slurry before removing the ethyl acetate using a rotary evaporator under vacuum. The silicone oil coated swollen PEI particles were then dried in an oven at 80° C. for 30 min prior to acidic gas capture testing.

Using either of the above deposition processes, the PEI particles were coated with either 4% w/w silicone oil or 10% w/w silicone oil. A photo of the silicone oil coated PEI particles is shown in FIG. 1B. The DEA swollen PEI particles before coating absorbed water instantly highlighting their non-hydrophobic nature, while the water droplets stayed intact with high contact angles on top of the oil coated DEA swollen PEI particles, as shown in FIG. 1B.

### Example 3: Effect Silicone Oil Coating has on CO₂ and H₂O Uptake

The effect of the silicone oil coating on the CO₂ and H₂O uptake was evaluated by placing a tray packed with the coated DEA swollen PEI particle on an analytical balance (readability of 0.0001 g, Mettler Toledo), where a cooling fan (120*120 mm) was placed at one side of the balance and blown passing through the tray at a speed of 1.2 m s⁻¹ to simulate a direct air capture (DAC) set up. The changes in weight of the packed tray owing to the absorption of CO₂ and H₂O were recorded at 5 min intervals for 1000 min. The uptake was calculated via

$$Uptake ( wt . \% ) = \frac{{W}_{i} - {W}_{t}}{{W}_{s}} \times 100 \%$$

where Wᵢ is the weight recorded every 5 min, Wₜ is the initial total weight of the tray, Wₛ is the initial weight of the support particles.

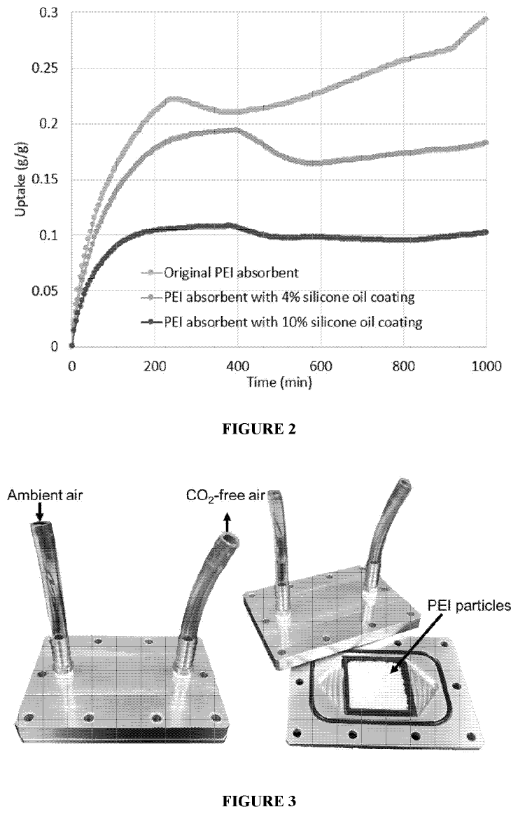

FIG. 2 shows the effect of silicone oil coating on water uptake of the DEA swollen PEI particles as a function of time. Compared with the original DEA swollen PEI absorbent (i.e. comprising no hydrophobe), those with silicone oil coating can greatly suppress water uptake, which is more pronounced with increasing the silicone coating loading to 10 wt. %. The water uptake of the DEA swollen PEI particles coated with 10 wt. % silicone oil coating peaked at 10.7 wt. % and can keep stable during the course of the testing. While the uptake of the original DEA swollen PEI particles without hydrophobe modification reached its first saturation point about 22.2 wt. % and continued to increase during the test. Silicone oil coating greatly increased the water repelling capability of the DEA swollen PEI particles.

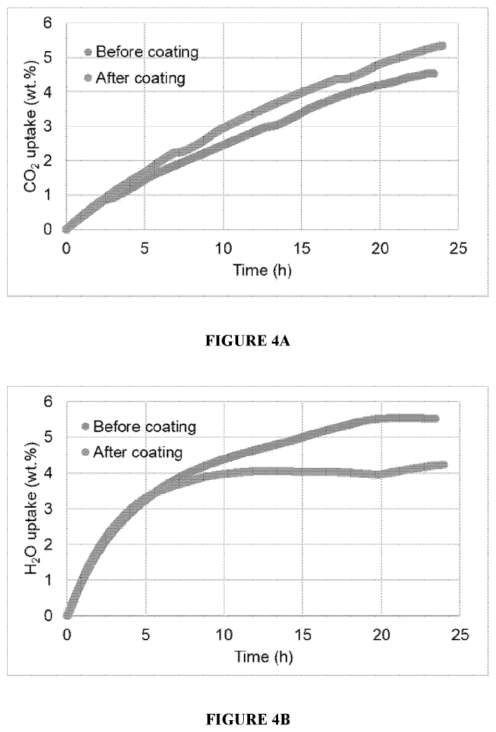

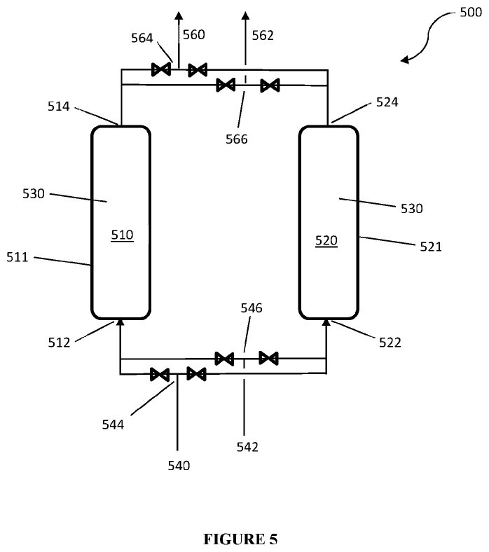

The CO₂ uptake and water uptake of the DEA swollen PEI particles before and after coating with silicone oil was also evaluated using a flow-cell testing rig as shown in FIG. 3, using CO₂ and humidity sensors (VAISALA), respectively. The CO₂ and H₂O uptake was calculated based on the differences between their inlet and outlet concentrations as a function of time for 24 h. FIG. 4A shows the CO₂ uptake and FIG. 4B shows the H₂O uptake of the DEA swollen PEI particles before and after the coating (10 wt. %). When the DEA swollen PEI particles was coated with 10% w/w of silicone oil, the water uptake reduced by 23.5% from 5.52 wt. % to 4.22 wt. %, while the CO₂ uptake surprisingly increased by 17.8% from 4.54 wt. % to 5.35 wt. %.

### Example 4: Preparation of Hydrophobe-Functionalised Amines for Absorbing on or within Support Particles

Various hydrophobe-functionalised liquid amines were prepared and absorbed within PEI particles, as shown below in Table 1. Briefly, the liquid amine is reacted with a glycidyl ether in a 1:1 molar ratio using ethanol or water as the solvent. The glycidyl ether reacts with the amine groups via an epoxide ring opening mechanism, where the C—O bond in the glycidyl ether is broken and the molecule is bonded covalently to the nitrogen of the amine group, replacing one hydrogen with a chain comprised of a hydroxyl, an ether, and a hydrophobic tail. Hydrophobe-functionalised amine liquid is then used to coat the DEA swollen PEI hydrogel particles prepared according to Example 1, at a weight ratio of hydrophobe to solid support particles of 1:1.

TABLE 1
Hydrophobe (e.g. glycidyl ether or epoxide) and amine used
to prepare various hydrophobe-functionalised amine liquids

| Glycidyl ether | Amine |
|---|---|
| Dodecyl and tetradecyl glycidyl ether | 2(2-amino)ethoxyethanol |
| Dodecyl and tetradecyl glycidyl ether | diethanolamine |
| Butyl glycidyl ether | ethylene diamine |
| Dodecyl and tetradecyl glycidyl ether | diamino propane |
| Dodecyl and tetradecyl glycidyl ether | monoethanolamine |
| Dodecyl and tetradecyl glycidyl ether | 2-amino-2-methyl-1-propanol |
| Cyclohexene oxide | Tetraethylene pentamine |

### Example 5: Effect Hydrophobe-Functionalised Amines had on CO₂ and H₂O Uptake

The CO₂ uptake of the DEA swollen PEI particles comprising hydrophobe-functionalised amine was evaluated using a flow-cell testing rig as shown in FIG. 3. The results are summarised in Table 2:

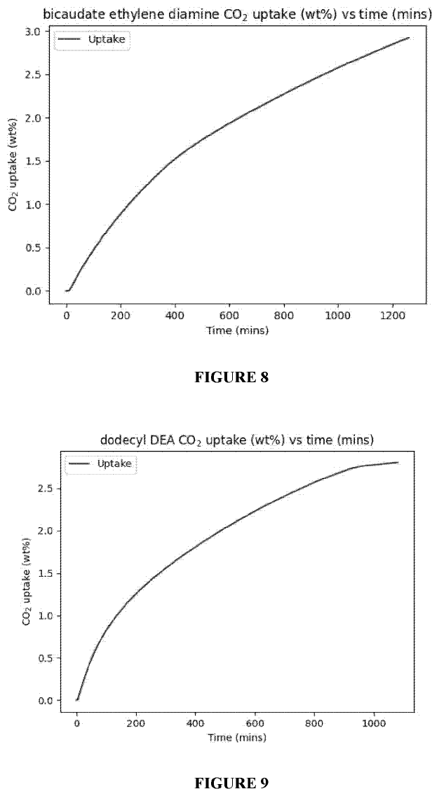

TABLE 2
CO₂ uptake of DEA swollen PEI particles comprising
hydrophobe-functionalised amine liquids

| Hydrophobe-functionalised amine | CO₂ uptake (wt %) after 800 |
|---|---|
| liquid on or within DEA swollen PEI | minutes measured using an air |
| particles | stream |
| Dodecyl and tetradecyl functionalised | −~1.6-1.8 |
| 2(2-amino)ethoxyethanol (FIG. 6) | |
| Dodecyl and tetradecyl functionalised | −~2.5 |
| diethanolamine (FIG. 9) | |
| Butyl functionalised ethylene diamine | ~2.0-2.5 |
| (also referred to herein as bicaudate | |
| ethylene diamine) (FIG. 8) | |
| Dodecyl and tetradecyl functionalised | 2-3 |
| diamino propane | |
| Dodecyl and tetradecyl functionalised | 2-5 |
| monoethanolamine | |
| Dodecyl and tetradecyl functionalised | 1-2 |
| 2-amino-2-methyl-1-propanol | |
| Cyclohexene oxide functionalised | 1.25-1.5 |
| tetraethylene pentamine (FIG. 7) | |
| None (DEA swollen PEI particles only) | ~3 after 800 mins (~13 hours). |
| (FIG. 4A) | |

The water uptake of DEA swollen PEI particles comprising no hydrophobe functionalised diethanolamine (DEA) was compared to PEI particles swollen with dodecyl and tetradecyl functionalised DEA using the flow-cell testing rig as shown in FIG. 3. PEI particles swollen with dodecyl and tetradecyl functionalised DEA had a water uptake of 2.4 wt. %, compared to 5 wt. % for DEA swollen PEI particles after 24 hours. While in some cases there is some trade off with CO₂ uptake, the reduced water uptake allows for improved gas absorption performance over repeated cycles due to decreased heating temperatures/times required desorb the water and CO₂ from the hydrogel, owing to less water being taken up from the atmosphere.

### Example 6: CO₂ and Water Uptake Using Porous Supports

Molecular sieves (MS) 13X pellets, 1.6 mm diameter were used as the support particles. The MS was loaded with monoethanolamine (MEA) at a weight ratio of 1:1. Silicone oil (10% based on the total weight of the MS+MEA) was added and mixed onto the MS support to provide a hydrophobe coating. A sample of MS+MEA was also prepared with no silicone oil coating. Both samples were left in 100% humid environment overnight. The MS+MEA comprising no silicone oil coating exhibited a 22.6 wt. % water uptake whereas the MS+MEA comprising the silicon oil coating exhibited 18.5% water uptake, an 18% reduction in water uptake.

The CO₂ uptake of the MS+MEA coated with silicon oil using a pure flowing CO₂ stream at ambient pressure was compared to the non-coated MS+MEA. The CO₂ uptake for both MS-MEA coated with silicon oil and non-coated MS+MEA was 11.6 wt. % and 10 wt. %, respectively. If the CO₂ uptake was scaled so as to exclude the weight contributed by the silicone oil, MS+MEA coated with silicon oil had a CO₂ uptake of 11.1 wt. %, indicating that despite the improved water repelling properties and therefore downstream advantages such as improved regeneration, the CO₂ uptake capacity was largely retained.

### Example 7: Fabrication of Hydrophobe Grafted Polyethylenimine Hydrogel Particles (“PEI”)

20 g of polyethylenimine (PEI) dissolved in 40 g of ethanol with 1 g of sodium phosphate was stirred until a uniform solution was obtained. Subsequently, 24 g of dodecyl and tetradecyl glycidyl ether was then added and stirred for 3 hours to covalently attach to amine groups of the PEI vis an epoxide ring opening mechanism where the C—O bond in the glycidyl ether is broken and the molecule is bonded covalently to the nitrogen of the amine group, replacing one hydrogen with a chain comprised of a hydroxyl, an ether, and a hydrophobic tail.

Next, 4 g of cross-linker (aqueous trimethylolpropane triglycidyl ether cross-linking solution) is then added to cross-link the remaining free reactive amines of the PEI to form the hydrogel and stirred until solidified and a bulk hydrophobe grafted PEI gel was produced. Afterward, the PEI gel was vigorously ground using a glass stirring rod to obtain a snow-like material of hydrophobe-grafted PEI particles that had an average particle size of 200~300 μm.

The hydrophobe grafted PEI particles were then swollen in liquid diethanolamine (DEA) based on a weight ratio of PEI to DEA in the range of 1 to 2.

### Example 8: Effect Hydrophobe Grafting has on CO₂ Uptake

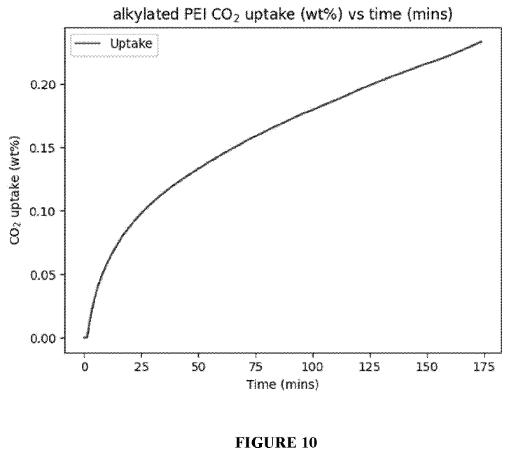

The CO₂ uptake of hydrophobe-grafted PEI particles swollen with DEA was evaluated using a flow-cell testing rig as shown in FIG. 3, using CO₂ sensors (VAISALA), respectively. FIG. 10 shows the effect of hydrophobe grafting has on CO₂ uptake of the DEA-swollen PEI particles as a function of time showing good CO₂ uptake despite the presence of the hydrophobic dodecyl and tetradecyl (e.g. alkyl) grafting. The CO₂ uptake of the hydrophobe-grafted PEI particles swollen with DEA was ~0.25 wt % after 175 minutes. By comparison however, the CO₂ uptake in DEA swollen PEI particles comprising physically absorbed hydrophobe-functionalised amine liquids was comparably higher after the same time period, and in some cases double the uptake (e.g. between ~0.5 wt % to 1 wt % for DEA swollen PEI particles comprising various hydrophobe-functionalised amine liquids, see FIGS. 6 to 9).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. An acidic gas absorbent particulate for capture of acidic gas, comprising hydrogel particles, and a hydrophobe physically absorbed on or within the hydrogel particles,
wherein the hydrogel particles contain absorbed liquid comprising an acidic gas absorbent for acidic gas, and the hydrophobe and acidic gas absorbent are different species, and
wherein the hydrophobe is a liquid or a wax, and at least some of the hydrophobe is absorbed on the surface of the hydrogel particles as a surface coating.

2-6. (canceled)

7. The acidic gas absorbent particulate of claim 1, wherein the weight ratio % of hydrophobe to hydrogel particles is between about 1:20 to about 1:1.

8. (canceled)

9. The acidic gas absorbent particulate of claim 1, wherein the hydrophobe is a surfactant, oil, wax, or a hydrophobe functionalised amine, or a mixture thereof.

10. The acidic gas absorbent particulate of claim 9, wherein the surfactant is an anionic or non-ionic surfactant, or a mixture thereof.

11-13. (canceled)

14. The acidic gas absorbent particulate of claim 9, wherein the oil is selected from a hydrocarbon oil or a polysiloxane, or a mixture thereof.

15. (canceled)

16. (canceled)

17. The acidic gas absorbent particulate of claim 9, wherein the hydrophobe-functionalised amine is a reaction product of the amine group and a nitrogen-reactive compound comprising the hydrophobe, wherein the nitrogen-reactive compound comprising the hydrophobe is a glycidyl ether, and the reaction product of the amine group and glycidyl ether comprises one or more of Formula 1a to 1d: 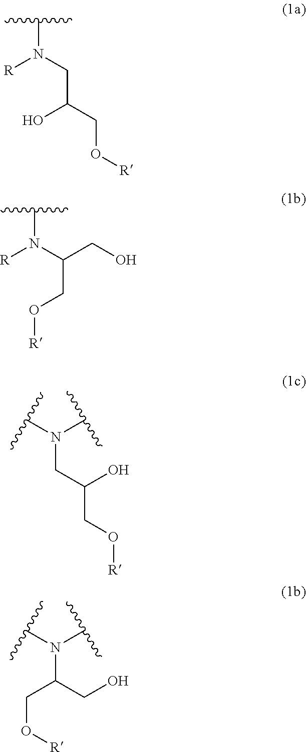
wherein
each R is independently selected from H, 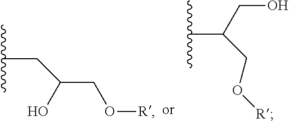
and
each R′ is independently an uninterrupted or interrupted and optionally substituted hydrocarbyl radical comprising between about 1 to about 30 carbon atoms; and [symbol]
represents an attachment point on the amine of the liquid amine.

18-24. (canceled)

25. The acidic gas absorbent particulate of claim 1, wherein the weight ratio % of absorbed liquid to hydrogel particles is between about 2:1 to about 5:1.

26. (canceled)

27. (canceled)

28. The acidic gas absorbent particulate of claim 1, wherein the acidic gas absorbent is a physical absorbent for acidic gas or a chemical absorbent for acidic gas, or a mixture thereof.

29. The acidic gas absorbent particulate of claim 28, wherein the physical acidic gas absorbent selected from the group consisting of methanol, dialkyl ether of polyethylene glycols, N-methyl-2-pyrrolidone, propylene carbonate, sulfolane, N-acetylmorpholine, N-formylmorpholine, alkanolpyridines and 1,3-dimethyl-3,4,5,6-tetrahydro-2(1H)-pyrimidinone.

30. The acidic gas absorbent particulate of claim 28, wherein the chemical acidic gas absorbent is an amine.

31. The acidic gas absorbent particulate of claim 30, wherein the amine is selected from the group consisting of monoethanolamine, ethylenediamine, 2-amino-2-methyl-1-propanol, 2-amino-2-methyl-ethanolamine, benzylamine, aminomethylpyridine, N-methylethanolamine, 2-(2-aminoethoxy)ethanol, amino-2-propanol, piperazine, piperidine, substituted piperidine, 3-piperidinemethanol, 3-piperidine ethanol, 2-piperidinemethanol, 2-piperidineethanol, diethanolamine, diglycolamine, diisopropanolamine, N-methyldiethanolamine, N-piperidinemethanol, N-piperidine, N,N-dimethylaminoethanol and 3-quinuclidinol and combinations thereof.

32-35. (canceled)

36. The acidic gas absorbent particulate of claim 1, wherein the hydrogel comprises a cross-linked polyamine.

37. The acidic gas absorbent particulate of claim 36, wherein the polyamine is a polyalkylenimine.

38. (canceled)

39. The acidic gas absorbent particulate of claim 37, wherein the polyalkylenimine is polyethylenimine.

40. A process for preparing an acidic gas absorbent particulate for capture of acidic gas of claim 1, comprising:
contacting the hydrophobe with hydrogel particles containing absorbed liquid comprising the acidic gas under conditions effective to physically absorb the hydrophobe on or within the hydrogel particles.

41. (canceled)

42. A method for removing an acidic gas from a gaseous stream or atmosphere, the method comprising contacting the gaseous stream or atmosphere with an acidic gas absorbent particulate of claim 1 to absorb at least some of the acidic gas from the gaseous stream or atmosphere into the absorbed liquid contained in the hydrogel particles.

43. (canceled)

44. The method of claim 42, wherein the gaseous stream or atmosphere is selected from the group consisting of combustion flue gas, hydrocarbon gas mixture, emission from cement or steel production, biogas and ambient air.

45-47. (canceled)

48. The method of claim 42, the method comprising:
providing a chamber enclosing the acidic gas absorbent particulate;
passing a flow of the gaseous stream or atmosphere through the chamber and contacting the acidic gas absorbent particulate to absorb at least some of the acidic gas into the absorbed liquid contained in the hydrogel particles; and
optionally heating the acidic gas absorbent particulate to a temperature effective to desorb the absorbed acidic gas from the hydrogel particles; and
optionally flushing the desorbed acidic gas from the chamber.

49. An acidic gas removal apparatus comprising a chamber enclosing an acidic gas absorbent particulate for capture of acidic gas from a gaseous stream or atmosphere of claim 1, wherein the chamber brings the gaseous stream or atmosphere into contact with the hydrogel particles to absorb at least some of the acidic gas into the absorbed liquid contained in the hydrogel particles.

50. (canceled)

51. (canceled)

52. The acidic gas absorbent particulate of claim 1, wherein the surface coating substantially covers the hydrogel particles.
